(19) United States
(12) Patent Application Publication
(10) Pub. No.: US 2023/0341234 A1
(43) Pub. Date: Oct. 26, 2023

(54) LANE PLANNING ARCHITECTURE FOR AUTONOMOUS MACHINE SYSTEMS AND APPLICATIONS

(71) Applicant: NVIDIA Corporation, Santa Clara, CA (US)

(72) Inventors: David Nister, Bellevue, WA (US); Hon Leung Lee, Bellevue, WA (US); Yizhou Wang, San Ramon, CA (US); Rotem Aviv, San Diego, CA (US); Birgit Henke, Seattle, WA (US); Julia Ng, San Jose, CA (US); Amir Akbarzadeh, San Jose, CA (US)

(21) Appl. No.: 17/725,175

(22) Filed: Apr. 20, 2022

(51) Int. Cl. G01C 21/36; G01C 21/34; B60W 60/00

(52) U.S. Cl. CPC G01C 21/3658; G01C 21/3446; G01C 21/3453; B60W 60/001; B60W 2556/40

(57) ABSTRACT

In various examples, a lane planner for generating lane planner output data based on a state and probabilistic action space is provided. A driving system—that operates based on a hierarchical drive planning framework—includes the lane planner and other planning and control components. The lane planner processes lane planner input data (e.g., large lane graph, source node, target node) to generate lane planner output data (e.g., expected time rewards). The driving system can also include a route planner (e.g., a first planning layer) that operates to provide the lane planner input data to the lane planner. The lane planner operates as second planning layer that processes the lane planner input data based at least in part on a state and probabilistic action space of the large lane graph and calculates a time cost associated with navigating from a source node to a target node in the large lane graph.

### BACKGROUND

For autonomous vehicles to navigate effectively through an environment, the autonomous vehicles need to generate a route plan to navigate between two or more locations. For example, planning and control components of the vehicle can be used to identify routes and actions, which can be performed by a vehicle for a particular drive mission towards a target. The planning and control components (e.g., route planner, lane planner, and/or behavior planner) may use perception and mapping information generated by and/or provided to the vehicle. For example, a directed graph may include perception and mapping information—representing drive planning states and actions—that can be used to facilitate performing operations associated with the planning and control components. The perception and mapping information may be exchanged between interfaces of the planning and control components to support navigating a vehicle.

Conventional lane planning in drive or route planning may operate with inputs (e.g., lane planner input data) that support generating outputs (e.g., lane planner output data). Inputs can include a map, a source, and a target, where the source and targets can be, for example, GPS positions—optionally associated with lanes—from a first point A to a second point B. The outputs can include routes and actions that can be performed by the vehicle. Actions can include instructions to execute, such as to stay in a lane, make a lane change, follow a lane merge, or take a lane split. A conventional lane planner can be configured so that only a limited set of actions are available to the vehicle, and thus exact actions are provided to navigate a vehicle without taking into account that the car might fail to execute the actions—e.g., for safety related issues, or because one or more instructed actions are not possible given current road or traffic conditions.

In this way, conventional lane planning can be based specifically on a deterministic approach. Operationally, a deterministic graph is generated and a search algorithm (e.g., Dijkstra's algorithm, A* search algorithm) is used to find the shortest paths between positions, while actions are modeled as fully deterministic. However, by way example, a vehicle may attempt a lane change or at least desire to make a lane change, but the lane change may be blocked by a contending vehicle, forcing the vehicle to stay in the current lane. In another example, at the last chance for a vehicle to make a lane change, the vehicle can be blocked, causing the vehicle to wait and not move forward in the lane. Thus, the current combination of inputs, outputs, and controls for performing actions can be limiting—and conventional lane planners do not provide sophisticated outputs for performing drive planning in driving systems in a manner that is not fully deterministic. As such, a more comprehensive driving system with an alternative basis for performing lane planning operations can improve computing operations and interfaces for driving systems.

### SUMMARY

Embodiments of the present disclosure relate to operating a lane planner to generate lane planner output data based on a state and probabilistic action space. The lane planner output data corresponds to lane detection and/or guidance data of a driving system that operates based on a hierarchical drive planning framework associated with the lane planner and other planning and control components. The lane planner processes lane planner input data (e.g., large lane graph, source, target) to generate lane planner output data (e.g., expected time rewards corresponding to edges between nodes of the large lane graph between the source and the target). The driving system can also include a route planner (e.g., a first planning layer) that operates to provide more high level or coarse route information as the lane planner input data to the lane planner—e.g., to provide a source location, a target location, and an initial, high level lane graph mapping a route between the source and the target. The lane planner may operate as (for example and without limitation) a second planning layer that processes the lane planner input data to generate a state and probabilistic action space represented as a more granular or “large” lane graph that includes a time cost associated with navigating from a source node to one or more target nodes. The lane planner communicates the lane planner output data to a behavior planner to cause identification of at least one action to be performed by the vehicle to traverse from node to node through the large lane graph from the source location (e.g., a location of the ego-machine) to a target node. The behavior planner may, in embodiments, use the large lane graph (e.g., including a plurality of optional actions with different time rewards) generated by the lane planner in addition to live perception to make decisions as to which edges of the large lane graph to follow, and thus which path to take through the environment. In some embodiments, the behavior planner may feed live perception information to the lane planner such that the lane planner can dynamically update the large lane graph, and the behavior planner can operate solely on the large lane graph populated with the live perception information.

In contrast to conventional systems, such as those described above, outputs from the lane planner can include an expected equivalent time reward for arriving at a node, where the expected equivalent time reward (alternatively referred to herein as “expected time reward) is, e.g., an optimal or best currently computed expected reward converted to time. The lane planner output data can also include actions with probability distributions. For example, each action encoded in an edge of a large lane graph edge may have a positive probability of failure. Operationally, the target node of an edge can be identified at random, and the expected equivalent time reward can be calculated by initially using a search algorithm such as (and without limitation) a Djikstra's algorithm to identify time costs from a source node to any large lane graph node. The time costs can be used in a value iteration—or variants of the value iteration—to calculate the expected equivalent time reward. As such, unlike conventional systems, expected equivalent time rewards in this technical solution are based on optimal expected values of time rewards and further take into account future uncertainty.

More specifically, lane planner output data may be generated based on reinforcement learning. Reinforcement learning may be implemented using a Markov Decision Process (“MDP”) that is associated with a collection of states and a collection of actions. Each action brings an existing state to a random output state, which triggers a reward. As part of the reinforcement learning, the large lane graph can be transformed into an MDP, where the large lane graph nodes correspond to states and edges correspond to actions with random output nodes. Negative edge costs correspond to rewards, and the expected time rewards may be calculated as optimal values.

In some embodiments, a modified value iteration method is used to control the number of iterations. The modified value iteration method computationally breaks the cycles of a large lane graph, so the graph becomes acyclic—and an order of nodes can be created so that the expected time rewards can be propagated efficiently towards the source node. Therefore, one iteration of the modified value iteration method—via this order—can return sufficiently good results, as opposed to conventional systems that required many iterations to generate a final result, which was both computationally and time intensive.

### BRIEF DESCRIPTION OF THE DRAWINGS

The present systems and methods to operating a lane planner to generate lane planner output data based on a state and probabilistic action space are described in detail below with reference to the attached drawing figures, wherein:

FIG. 1A is an example system for generating lane planner output data, in accordance with some embodiments of the present disclosure;

FIG. 1B is an example system for generating lane planner output data, in accordance with some embodiments of the present disclosure;

FIG. 1C is an example data flow diagram for generating lane planner output data, in accordance with some embodiments of the present disclosure;

FIGS. 2A-2G are example visual representations of lane planning data for generating lane planner output data, in accordance with some embodiments of the present disclosure;

FIGS. 3A-3D are example visual representations of calculations for generating lane planner output data with a modified value iteration algorithm, in accordance with some embodiments of the present disclosure;

FIGS. 4A-4B are example visual representations of lane planning data for generating lane planner output data, in accordance with some embodiments of the present disclosure;

FIGS. 5-6 are flow diagrams showing methods for providing lane planner output data, in accordance with some embodiments of the present disclosure;

FIG. 7A is an illustration of an example autonomous vehicle, in accordance with some embodiments of the present disclosure;

FIG. 7B is an example of camera locations and fields of view for the example autonomous vehicle of FIG. 7A, in accordance with some embodiments of the present disclosure;

FIG. 7C is a block diagram of an example system architecture for the example autonomous vehicle of FIG. 7A, in accordance with some embodiments of the present disclosure;

FIG. 7D is a system diagram for communication between cloud-based server(s) and the example autonomous vehicle of FIG. 7A, in accordance with some embodiments of the present disclosure

FIG. 8 is a block diagram of an example computing device suitable for use in implementing some embodiments of the present disclosure; and

FIG. 9 is a block diagram of an example data center suitable for use in implementing some embodiments of the present disclosure.

### DETAILED DESCRIPTION

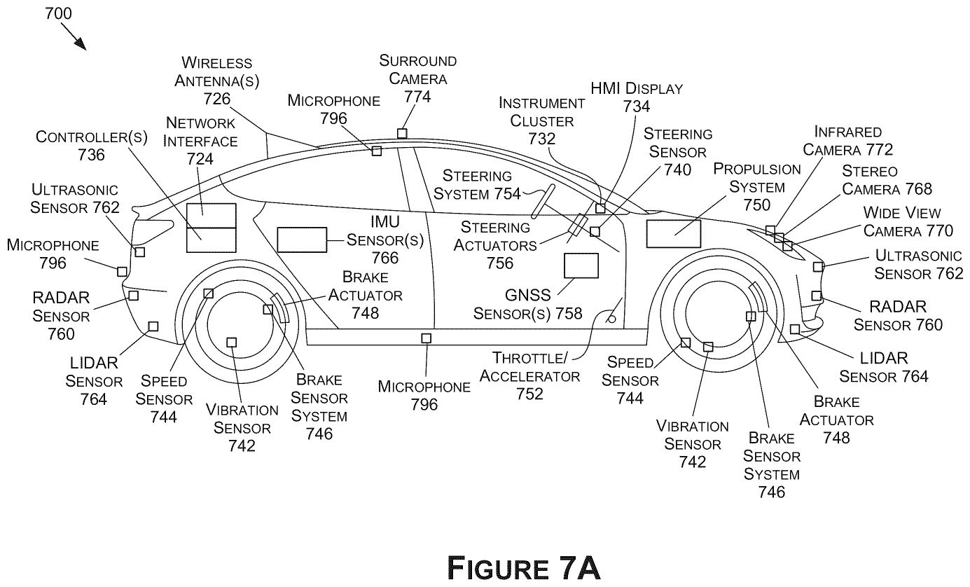

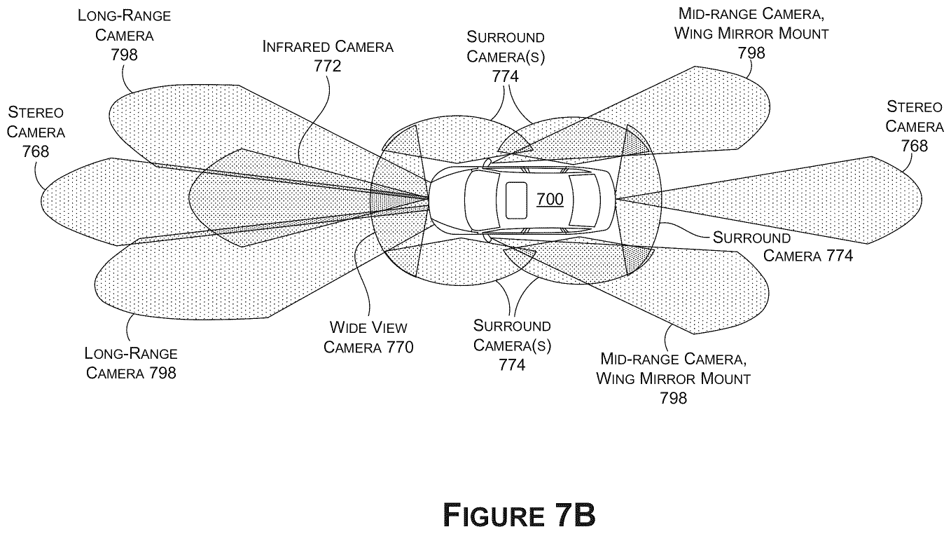

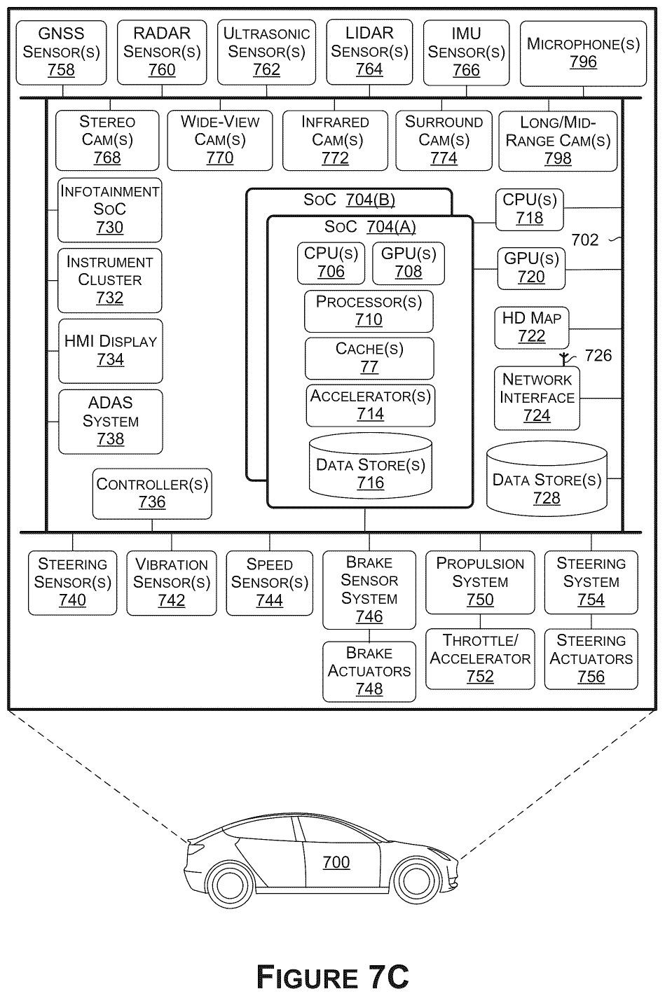

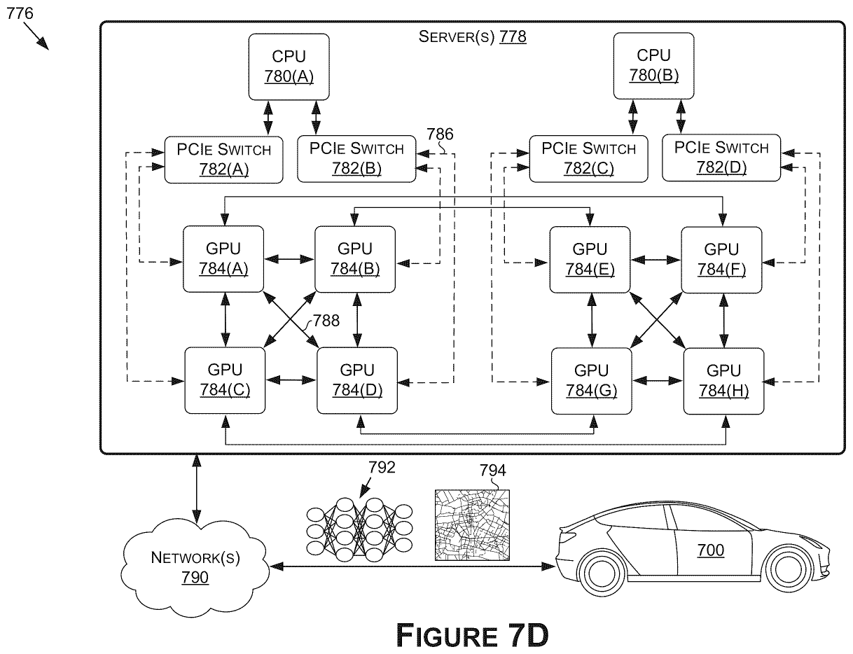

Systems and methods are disclosed related to operating a lane planner to generate lane planner output data based on a state and probabilistic action space. Although the present disclosure may be described with respect to an example autonomous vehicle 700 (alternatively referred to herein as “vehicle 700” or “ego-machine 700,” an example of which is described with respect to FIGS. 7A-7D), this is not intended to be limiting. For example, the systems and methods described herein may be used by, without limitation, non-autonomous vehicles, semi-autonomous vehicles (e.g., in one or more adaptive driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. In addition, although the present disclosure may be described with respect to lane planning for autonomous vehicles, this is not intended to be limiting, and the systems and methods described herein may be used in augmented reality, virtual reality, mixed reality, robotics, security and surveillance, autonomous or semi-autonomous machine applications, and/or any other technology spaces where lane or path planning may be used.

The systems and methods described herein may be used by, without limitation, non-autonomous vehicles, semi-autonomous vehicles (e.g., in one or more adaptive driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, autonomous or semi-autonomous machine applications, deep learning, environment simulation, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems implemented using an edge device, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems implemented at least partially using cloud computing resources, and/or other types of systems.

Embodiments of the present disclosure are directed to operating a lane planner to generate lane planner output data based on a state and probabilistic action space. In operation, data representative of at least a portion of a large lane graph associated with a driving route of a vehicle is received. The large lane graph includes a plurality of nodes indicative of potential locations within one or more lanes of the large lane graph and a plurality of edges connecting the plurality of nodes, at least one edge of the plurality of edges corresponding to a respective vehicle action of the vehicle within one or more lanes (e.g., local lanes). For at least one edge of the plurality of edges, a cost function is computed based at least in part on an expected equivalent time for traversing between the starting node and a connected node. Based at least in part on the one or more lanes, candidate vehicle actions and one or more driving routes for each candidate vehicle action. Based at least in part on the cost function associated with each edge, an expected equivalent time reward is computed for at least one node, so that a determination of a driving route is made. The vehicle is controlled along the driving route.

Overview of Hierarchical Drive Planning in a Driving System

Embodiments of the present disclosure are directed to a driving system that operates based on optimization categories, a conversion mechanism, and state and probabilistic action spaces. The driving system further operates based on a hierarchical planning framework including a state and action space for hierarchical planning. In embodiments, hierarchical planning may be decomposed into route planning, lane planning, and behavior planning. Route planning, lane planning, and behavior planning may be performed using a route planner, a lane planner, and a behavior planner, respectively, in embodiments, and the route planner, lane planner, and behavior planner may communicate between and among one another to determine control decisions for an ego-machine.

As discussed in more detail herein, equivalent times or near equivalent units of time are implemented to enable a connection between drive planning layers, for example, a connection between a first planning layer (e.g., route planning) and a second planning layer (e.g., lane planning). The drive planning based on equivalent times can be especially beneficial in drive planning for drive missions where there are multiple candidate routes. Implementation details for making the connection between layers may vary. At a high level, Global Navigation Satellite System (“GNSS”) coordinates along candidate routes with similar expected rewards can be used as guiding targets for a next layer of planning. In this way, a first planner (e.g., a route planner) supports continually providing a guiding target point—e.g., a few miles away—along a potential route towards a target. The guiding target point allows a next planner (e.g., a lane planner) in the autonomous driving pipeline to operate with the target point as a goal, thus abstracting away longer term goals and providing a simpler planning problem at a smaller scale that can be evaluated at greater detail.

With reference to the driving system, the driving system can be configured to optimize for a set of optimization categories. The set of optimization categories may include a target reward, time spent, resource spent, discomfort, comfort, obstacle safety, path obedience, wait condition obedience, and/or other categories. The set of optimization categories may be defined as rewards or costs, and can be configured as tradeoffs when navigating to a target. In order to implement optimization categories as tradeoffs, a conversion mechanism between the optimization categories can be defined so that the rewards or costs quantify each of the optimization categories. In some embodiments, one or more of the optimization categories (e.g., safety) may be defined with hard constraints rather than costs.

In at least one embodiment, the conversion mechanism between optimization categories can be time. For example, a target reward—as defined in time units—can be calculated relative to the other optimization categories, also defined in time units. In particular, there exists some allocation or budget (amount) of time (e.g., equivalent time once all costs are factored in) that can be expended that would determine whether or not a driving mission to a target can be performed. The other optimization categories can subtract equivalent time from the target reward. For example, path obedience (e.g., norm of centering in lanes or the nominal path of an environment) or wait conditions (e.g., traffic lights or right of way) will subtract from an equivalent time of a target reward.

Implementing time as a conversion mechanism can be supported by a state and action space. In the state and action space, the time-based expected reward (or expected time reward) can be implemented to model the construct of optimization categories having equivalent times. The model can be based on a Markov Decision Process (“MDP”) framework that is commonly used in reinforcement learning. For example, the state of the world is modeled by a state and action space, and in each state a particular action can be selected from a set of actions, and each action can result in a probability distribution over the next state and rewards for the transition of state. The state and action space may be represented using a “large” lane graph that may include a plurality of intermediate nodes extending along different lanes or paths of the lane graph between a source node (e.g., a current location of the ego-machine) and a target node (e.g., a node corresponding to one or more destinations of the ego-machine), with nodes connected via edges that represent actions.

The state and action space includes probabilistic modeling, such that, a single next state is not attached to each action. For example, an action may be taken to initiate a lane change, but the action may or may not succeed, resulting in being in the next lane over or staying in a lane. Moreover, the state and action space could advantageously model some aspects by probability or expectations, such as the expected time to traverse a particular stretch of road. In this regard, rewards are managed in terms of expected rewards, such that, the operational goal becomes to maximize the expected rewards (e.g., reward minus cost—all expressed in equivalent time) by choice of actions. The state and probabilistic action space operationally defines a Q—learning or value iteration that supports estimating the expected time reward starting from a state and continuing with the best policy (e.g., best sequence of actions).

The driving system further operates based on a hierarchical planning framework. The complexity of drive planning can be reduced based on hierarchical decomposition defined in the hierarchical planning framework. The hierarchical framework can operate based on a modeled state and action space that may be modeled in terms of several layers spanning between longer term models and short term models. The long term models contemplate large scale states and actions further from a current state—this supports faster and simpler modeling. The short term models contemplate small states and actions closer to a current state—this supports precise modeling and also the capacity to achieve longer term goals via a divide-and-conquer approach that relies on more simple and manageable actions.

State and action representation supports hierarchical planning in that a coarse state and action space can be used to compute expected rewards. For example, a subset of favorable states can be identified from a coarse state, such that, a next layer can use the terminal nodes of the coarse state. The coarse state can be then linked to a more detailed state and action representation but at a smaller scale. A handoff can be defined, where the largest planning layer spans a full planning problem with each next layer efficiently computing finer planning problems.

Drive planning can be decomposed into route planning, lane planning, and behavior planning. Route planning can represent the largest and coarsest scale of planning (e.g., road level coarseness at the scale of a continent). Lane planning—an intermediate planning level—can represent choices of lanes, lane changes, and fork and turn choices at the detail of individual lanes (e.g., at scale a few kilometers). Behavior planning can represent implementations including lane keeping, lane changes, forks and turns by turning them into motion plans, and finally control, which turns motion plans into actuation actions.

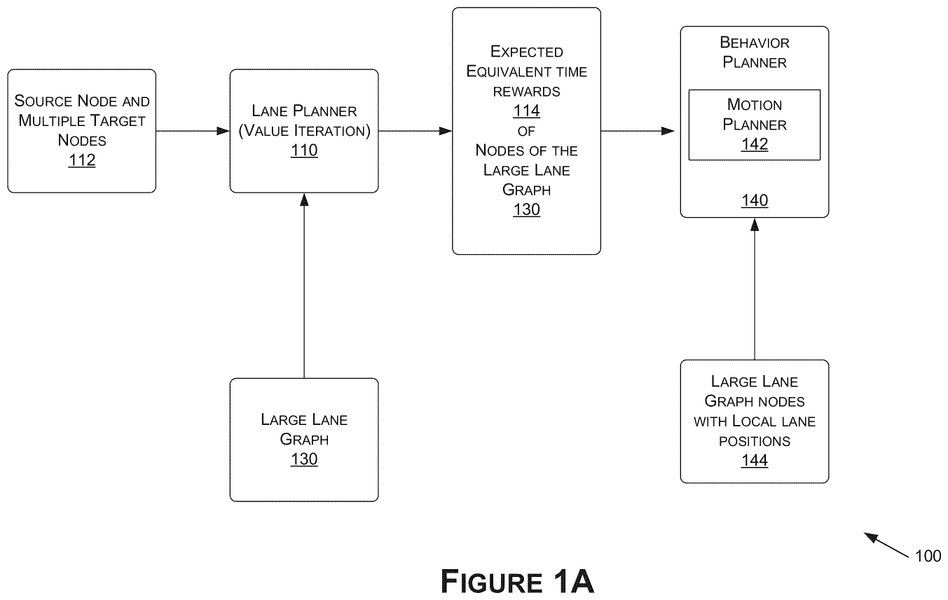

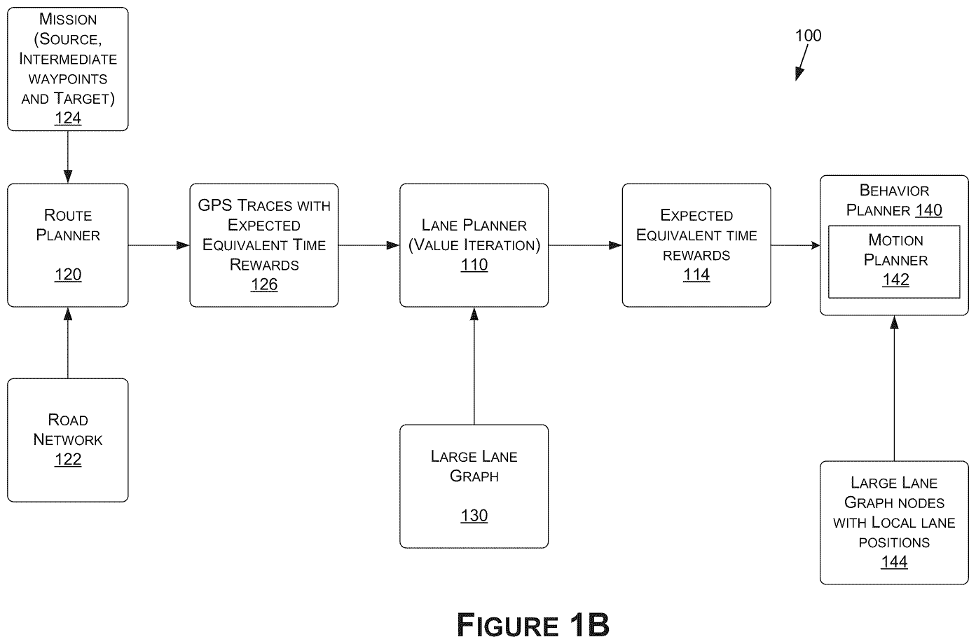

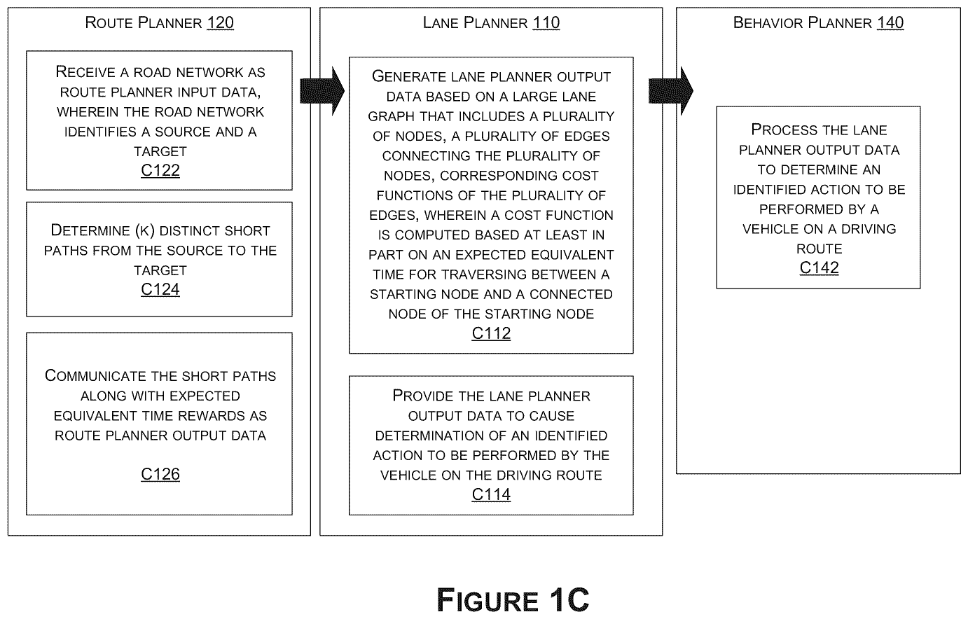

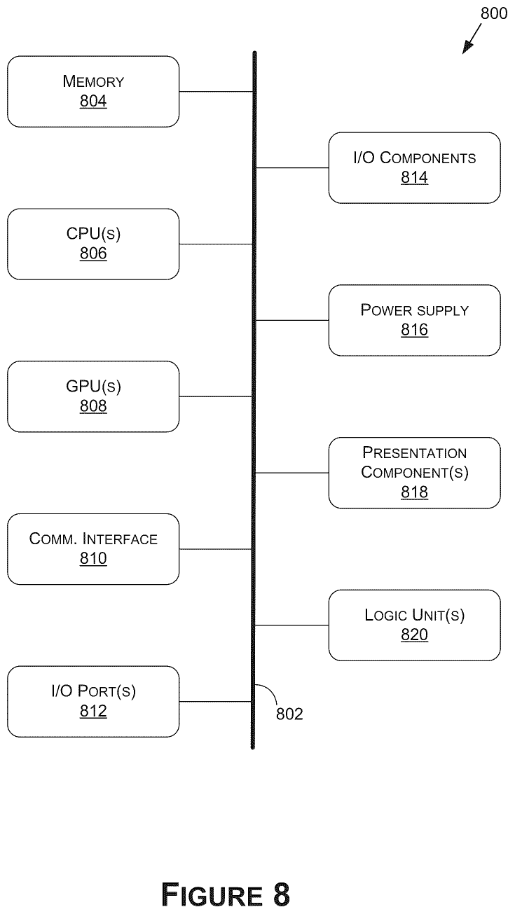

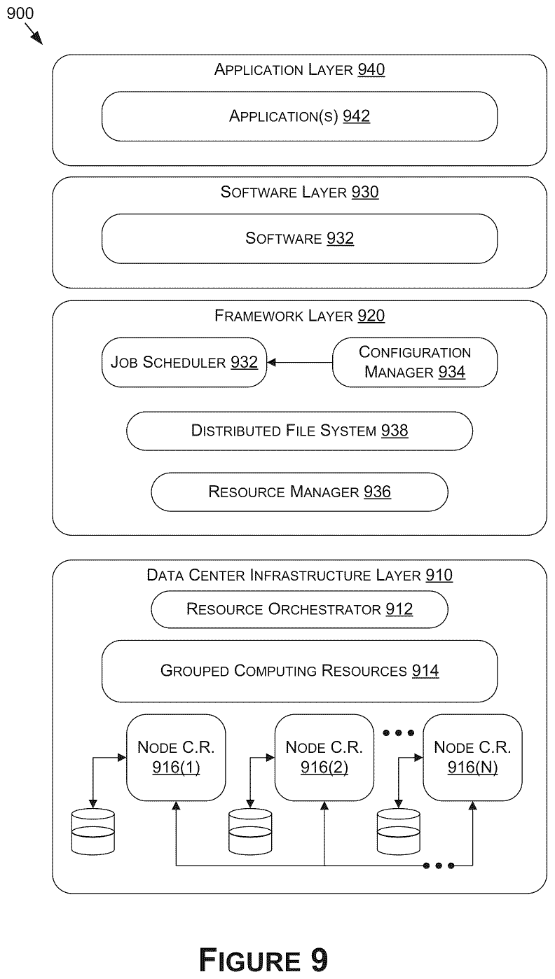

With reference to FIGS. 1A-1C, FIGS. 1A-1C include an example system 100 including a lane planner in accordance with some embodiments of the present disclosure. For example, the system 100 may operate a lane planner to generate lane planner output data based on a state and probabilistic action space. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In some embodiments, the system 100 may include similar components, features, and/or functionality as example autonomous vehicle 700 of FIGS. 7A-7D, example computing device 800 of FIG. 8, and/or example data center 900 of FIG. 9.

The system 100 provides components and operations for providing lane planner output data based on a state and probabilistic action space. The lane planner output data corresponds to lane guidance data of a driving system that operates based on a hierarchical drive planning framework associated with the lane planner and other planning and control components. As shown in FIG. 1A—and discussed in more detail below—the components include the following: lane planner 110 (value iteration), source node and multiple target nodes 112, expected equivalent time rewards 114 of nodes in the large lane graph 130, behavior planner 140 including motion planner 142 and large lane graph nodes linked with local lane positions 144. The components and operations in FIG. 1A correspond to the components and operations in FIG. 1B and FIG. 1C as described herein.

Route Planner

Turning to the route planner 120 (FIG. 1B), in one or more embodiments, the route planner 120 may be implemented as the coarsest and largest planning layer. The route planner 120 is responsible for planning at—for example—the scale of a continent, or as large as a defined large map area. The route planner 120 can operate to provide canonical outputs that allow the route planner 120 to be flexibly replaced. A route planner 120 can operate in a manner similar to modern navigation routes. In some embodiments, the route planner 120 performs operations with sufficient frequency to be able to adapt to a current location, a change in target, or other conditions.

At a high level, the route planner 120 receives a road network 122 as route planner input data. The road network identifies a source and a target (included in mission 124). A few (k) distinct short paths can be determined from the source to the target, where each of the short paths has an expected equivalent time 114 from the source to the target. The expected equivalent times 114 can be communicated as the route planner output data to the behavior planner 140.

The route planner 120 provides an interface to communicate route planner output data. The route planner output data can be a defined number (e.g., k) of Global Positioning System (“GPS”) or GNSS traces with corresponding expected equivalent times for each coordinate. A GPS trace, in one example, can be a list of locations in the World Geodetic System 1984 (“WGS84”) coordinate system. Each GPS location has an attached expected equivalent time, which is an expected reward for the remainder of a drive mission if starting at a current GPS location. In this way, the route planner 120 constructs a directed graph approximation (“graph approximation” or “directed graph data structure”) of a road network using a first map (e.g., best map available, such as an HD map, a GPS map, etc.). The graph approximation can include nodes and edges associated with the road network. The nodes in the graph may correspond to GPS coordinates in a simple version of the road network. The edges may connect the nodes together. Each edge may be annotated with an expected equivalent time (e.g., an amount of time to traverse the nodes associated with the respective edge). As such, the expected equivalent time on an edge may be set equal to the average expected cost spent traversing the edge. The graph approximation can include auxiliary information such as traffic conditions, turn difficulties, etc. The auxiliary information can include information from a fleet of cars regarding traffic conditions, and the route planner 120 may be executed in a drive system in the vehicle or in a cloud computing location. The graph approximation may take into account one or more optimization categories.

Operationally, by way of example, a user may specify a target via a GPS coordinate or address. The target can be converted to one of the nodes of the road network 122, and that node is processed as the target node. A target reward, in terms of equivalent time, is assigned to the target node. In principle, rewards may be assigned to multiple targets, or identified nodes that represent aborting the mission with no rewards; however, in a simplified implementation, rewards may be based on a single target node for the route planner 120. Operations performed by the route planner 120 are captured in the state and action space. In particular, each node corresponds to a state, and each outgoing edge from a node represents the action of traveling from that node to the next.

Actions result in deterministic outcomes, and edges carry a positive cost (e.g., expected equivalent time spent), and there exists a single target and target reward. Drive planning (e.g., a full planning problem) includes operations that calculate the expected reward starting from any of the nodes. The calculation corresponds to finding the shortest path (e.g., an expected equivalent time spent seen as a distance of each edge) from each node to the target. The expected reward at each node is then the target reward minus the cost of the shortest path from the node to the target. If the expected reward is negative, the shortest path is more expensive than the target reward. In this scenario, the expected target reward can be truncated to zero, corresponding to aborting the mission if the drive planning arrives at that node.

Drive planning, via the route planner 120, can implement several efficiencies. For example, the expected reward for each node in the road network 122 is unnecessary and expensive to compute or transmit through the route planner interface. Instead, the route planner 120 operates based on a specific source node—the current position on the road network 122. A user of the route planner 120 may specify a current source node—such as by snapping a current GPS position to a nearest node, or by tracking along the road network 122. The route planner 120 operates efficiently in that the route planner 120 determines a shortest path from the source node to the target node (e.g., identified in the mission 124) and computes the expected reward 114 for each of the nodes along that shortest path. Additional efficient solutions for finding the shortest path through a road network 122 exist. For example, a contraction hierarchy data structure supports routing at a continent scale at millisecond speeds on mobile computing platforms, given a source and a target. Operationally, a compact data structure (e.g., a contraction hierarchy) is constructed in a pre-processing step from a road network 122. Using the contraction hierarchy, the live routing processing becomes a bi-directional Dijkstra's search with a restriction that each direction of search is limited to going upwards in the contraction hierarchy. In this way, the shortest path for the source and target is searched on the next larger road (e.g., onto a highway) and the searching operations converge at high level of hierarchy. In one or more embodiments, the hierarchy is continuous with each node occupying its own level.

The route planner 120 can be configured to use different types of implementations for route planning. Any route planner 120 that can produce GPS traces for the preferred routes can be used. For example, an external route planner can communicate GPS traces or a single GPS trace without expected rewards. A curve integral of distance traveled associated with the GPS trace can be used as a surrogate for the equivalent times. If expected time along the route is given, that can be used to calculate, for each node, the expected time left, and it can be subtracted from the target reward to create equivalent times.

With reference to the route planner 120 in FIG. 1C, at a high level, the route planner 120, at C122 receives a road network 122 and mission (source, intermediate waypoints, and target) 124 as route planner input data. The mission 124 identifies a source and a target with respect to the road network 122. A few (k) distinct shortest paths can be determined from the source to the target, at C124. Each of the shortest paths having expected equivalent time rewards 124 at each node from the source to the target. The shortest paths with expected equivalent time rewards can be communicated out as the route planner output data, at C126 (e.g., GPS traces with expected equivalent time rewards 126).

The route planner 120 communicates the lane planner input data to the lane planner 110. The lane planner input data 122 may include at least the portion of a large lane graph 130 having a plurality of annotated nodes and a plurality of annotated edges. In particular, the route planner 120 provides lane planner input data that is processed at the lane planner 110 to generate lane planner output data that is communicated to the behavior planner 140 to cause identification of at least one action to be performed by the vehicle.

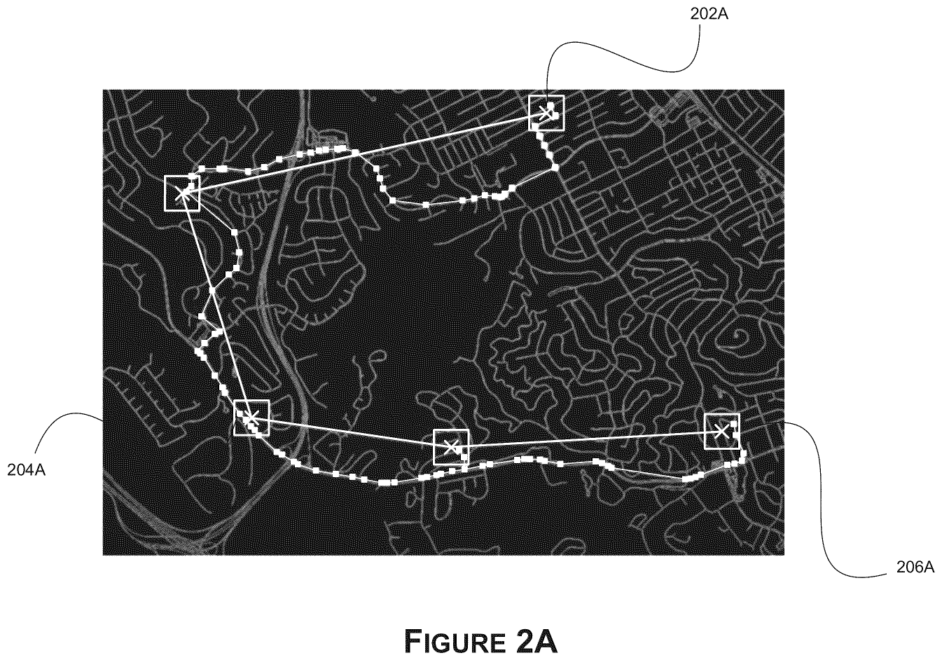

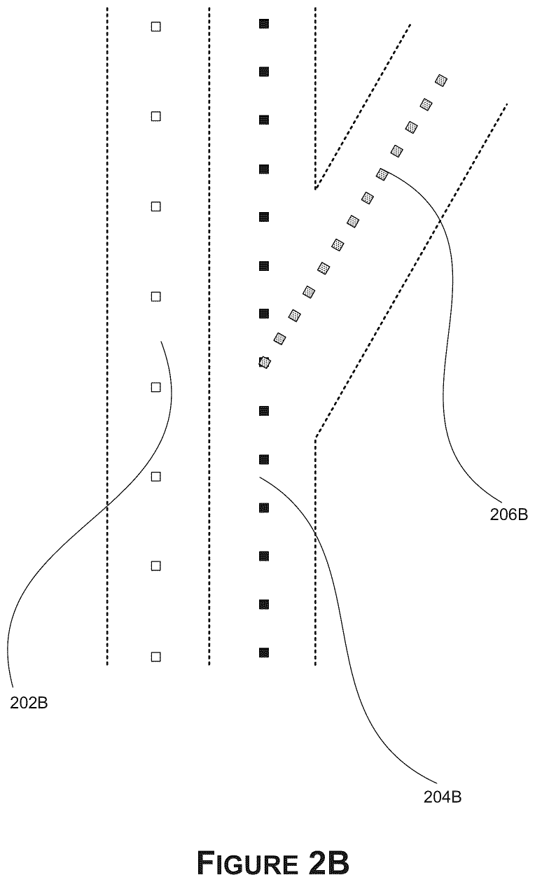

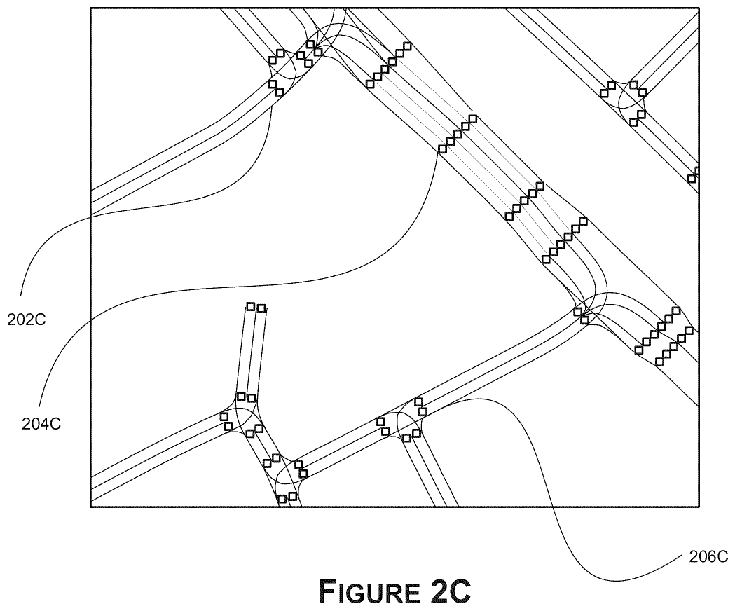

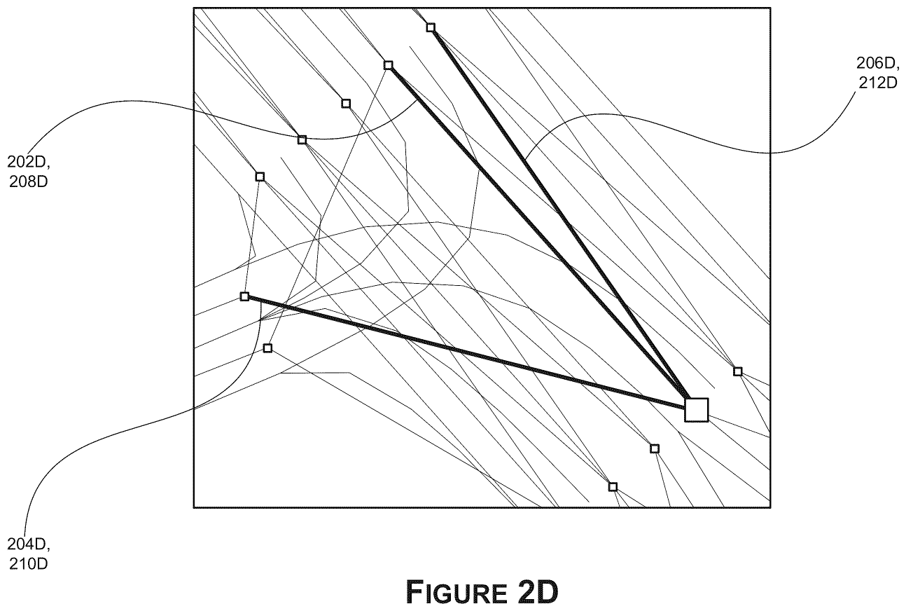

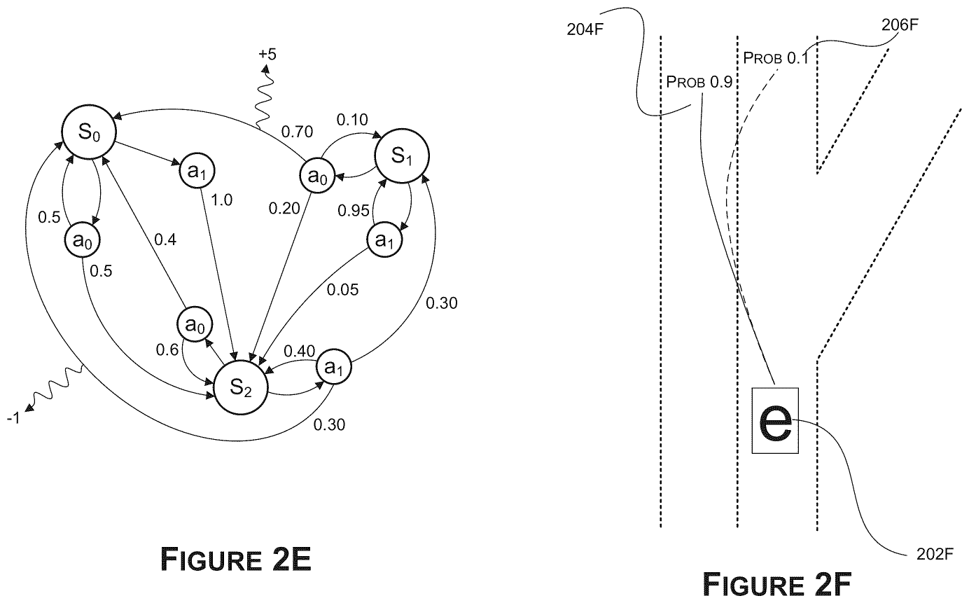

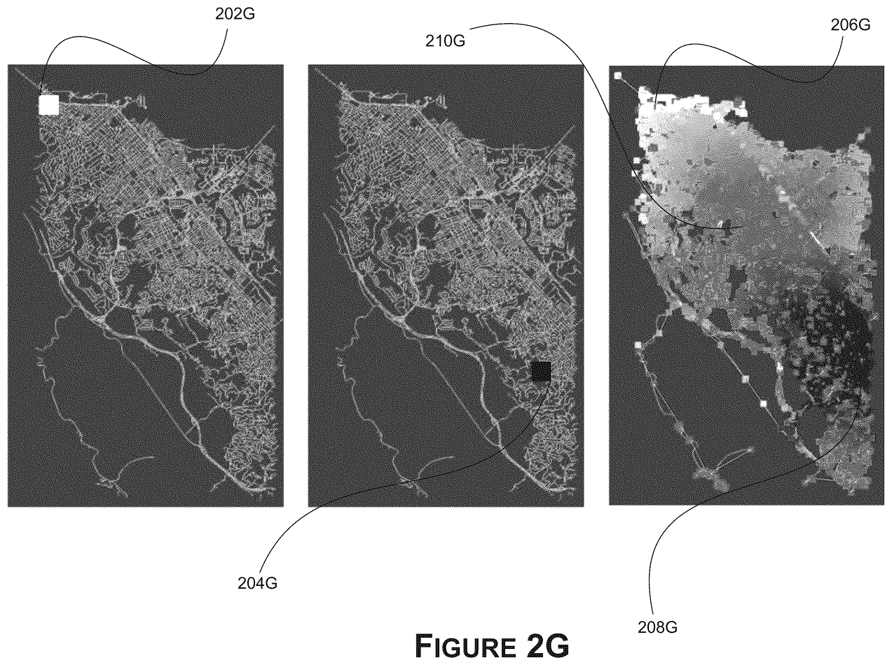

With reference to FIG. 2A, FIG. 2A illustrates a schematic representation of route planning based includes waypoints (e.g., waypoint 202A, waypoint 204A, and waypoint 204C). The waypoints may specifically correspond to a large lane graph cropping (e.g., a subgraph of a large lane graph 130). As discussed, the subgraph of the large lane graph 130 can include expected time rewards 114 of target nodes provided by the route planner 120 (e.g., a source node to a gas station intermediate target node supported via a lane planner, and the gas station to home—final target node—supported by the route planner 120). In this way, the route planner 120 constructs a directed graph approximation (“graph approximation” or “directed graph data structure”) of a road network 122 using a first map (e.g., best map available). The graph approximation can include node and edges associated with the road network 122 (e.g., a plurality of annotated nodes and a plurality of annotated edges). The nodes in the graph correspond to GPS coordinates in a simple version of the road network 122. The edges connect the nodes, and each edge may be annotated with an expected equivalent time 114. For example, the expected equivalent time 114 on an edge may be the cost that on average is expected to be spent traversing the edge. The directed graph can include auxiliary information such as traffic conditions, turn difficulties, etc. The auxiliary information can include information from a fleet of cars regarding traffic conditions, and the route planner 120 may be executed in a drive system in the vehicle or in a cloud computing location. The graph approximation may take in account one or more optimization categories.

Lane Planner

Referring to FIG. 1B, FIG. 1B illustrates the example system 100 that operates to provide a lane planner 110 that generates lane planner output data (e.g., expected equivalent time rewards 114 of FIG. 1A) based on a state and probabilistic action space of a large lane graph 130 in lane planner input data (e.g., source node and multiple target nodes 112 of FIG. 1A or GPS traces with expected equivalent time rewards 126 received from a route planner (e.g., route planner 120)). The lane planner output data corresponds to lane guidance data of a driving system that operates based on a hierarchical drive planning framework associated with the lane planner and other planning and control components. The lane planner 110 provides the lane planner output data 114 to cause a behavior planner (e.g., behavior planner 140) to determine an action (e.g., via motion planner 142 of FIG. 1A) to be performed by a vehicle on a driving route.

The lane planner input data 112 can include a source, a target, and the large lane graph 130. At least some of the inputs can be received from the route planner. For example, a route planner communicates waypoints (e.g., GPS trace or route points or locations expressed as Global Positioning System (“GPS”) coordinates) associated with a drive plan for a vehicle. The waypoints are used to identify a subsection of the large lane graph 130 utilized by the lane planner. The route planner 120 also provides expected equivalent time rewards 126 for waypoints including a final target node of the drive plan. For example, a waypoint can represent an intermediate target, like a gas station, or a final target, like a home, of the drive plan. In addition, the waypoints can also be used to set guiding targets when the geometric scope of the lane planner is limited. The lane planner consumes the expected time rewards of the guiding targets to estimate the expected time rewards of large lane graph nodes within its scope. For example, if there is only one guiding target in the boundary of the lane planner's scope with 1000 seconds of expected time reward, and if the best time cost from a large lane graph node to the guiding target is 300 seconds, then 1000-300=700 seconds is the expected time reward of this large lane graph node. Waypoints can further be used to impose penalties on the edge equivalent time costs or node expected equivalent time rewards, in order for the lane planner 110 to prefer actions that follow the route points closely.

As such, the lane planner 110 connects at a next level of detail below the route planner 120. The lane planner 110 supports explicitly operating each of the lanes along a roadway. State is connected to positions in and along a particular lane, in contrast to roads. The lane planner 110 operates at the next level of detail based on data structures that represent a lane-aware state and probabilistic action space.

The lane planner 110 also performs operations using the data structures and the data represented in the data structures. In one embodiment, the data structure is a large lane graph 130. The large lane graph 130 may be different from a local lane graph, which is related to a smaller scope that is relevant to perception mapping (e.g., via the behavior planner 140). The large lane graph 130 may be represented in terms of a number of nodes, where the nodes can be vertices in the center of a lane at some longitudinal progress. The large lane graph 130 represents the state and action space in that the nodes represent potential positions for a vehicle 700 along and in a lane.

The nodes may also have additional information (e.g., additional annotation data) attached to them, in particular at least one GNSS coordinate. Additional GNSS coordinates can be associated with a node when the node represents a denser sampling of the lane (e.g., denser sampling of lane data) until the next node. The actions may be represented by edges between nodes, and the actions may correspond to: moving forward in a lane to a next node; lane changes left or right to a next lane; or various choices of forking or turning—all represented by the target node of the edge. The edge can also have information that includes a type of maneuver the edge represents, and each edge can be associated with an expected equivalent time 114 that represents the expected average cost spent while traversing the edge. The equivalent time 114 may be defined as an average, but in the alternative, may be further informed by current traffic conditions. In some embodiments, an edge can also be modulated by a type of maneuver.

A primary mechanism for forming the large lane graph 130 includes mapping and/or perception operations. The large lane graph 130 may be generated with values on the edges (e.g., value informed by averages, averages adapted by time of day, averages informed by current conditions learned from a fleet of vehicles), and the edges near a current position of the vehicle 700 may be further augmented using averages informed by live perception of a plurality of factors (e.g., velocities, occupation of lanes, and states of traffic lights).

The large lane graph 130 may be handed off from the route planner 120 to the lane planner 110. For example, the route planner 120 generates a first representation of the large lane graph 130 and communicates the large lane graph 130 to the lane planner 110. The route planner 120 may use a current route plan as a guide. By way of example, the route plan can be expressed in k GPS traces, such that, a subgraph of the large lane graph 130 is extracted from the large lane graph 130. The route planner 120 then performs mapping operations to generate the first representation of the large lane graph 130. The large lane graph 130 includes large lane graph data (e.g., states and actions, or equivalently nodes and edges with equivalent times) that may be used or represented in the subgraph of the large lane graph 130.

The subgraph of the large lane graph 130 may be a part inside a corridor of some fixed width (e.g., 300 m) around each of the k GPS traces provided via the route plan, starting from a current position of the vehicle to some expected equivalent time spent compared to the current position. For each of the GPS traces, the route planner 120 is configured to process the same expected equivalent time 114. Processing each GPS trace in this manner allows the transition between the lane planning and route planning to occur at a similar spent equivalent time along each GPS trace.

A total time can be limited by targeting a fixed number of nodes in the subgraph considered for lane planning. If the scope along a GPS trace reaches the target, the corridor is based on the current position to the target. If the scope along the GPS trace does not reach the target, the corridor may extend up to the furthest out GPS point considered along the trace. Next, all nodes within a defined radius (e.g., 100 m) in the large lane graph 130 may be identified. The nodes are assigned the expected equivalent time reward of the GPS point closest to them, plus a penalty for the distance to their closest GPS point. The nodes close to the further out GPS points along each trace are treated as target nodes for the lane planning. These target nodes may be referred to as proxy targets or guiding targets. In this way, the operations computationally splice together the large lane graph 130 with the route plan so that the quality of the total plan can be calculated as the expected time reward 114 at one of the target nodes minus the expected equivalent time 114 expended in the lane plan in order to get to the target node.

As discussed, a search radius restriction (e.g., 100 m) may be implemented by the lane planner 110. A reason for the search radius restriction relates to limit discrepancies in the maps when executing hand-offs for route planning and lane planning. And a reason for using a corridor around the GPS trace is to allow the lane planning to do more detailed planning than the map used in routing allowed, while using a heuristic that the deviation between the lane plan and route plan should not need to be much more than half the width of the corridor, allowing for more efficiency than if searching in all directions.

Operationally, lane planning can be performed for a defined distance (e.g., for a few miles) along each GPS trace. The defined distance can be configured such that the defined distance is long enough to make detailed lane planning beyond that distance unnecessary. To support traversing an existing route plan more precisely, the operations can optionally penalize deviations from the GPS trace by adding a penalty to the nodes or edges based on their distance from the GPS trace. However the penalty may not be derived from the initial set of reward categories.

The large lane graph 130 (e.g., a subgraph of the large lane graph 130) can be generated such that the goal of the computational process is to determine the expected equivalent time 114 for each node in the large lane graph 130. That is, the equivalent time that is expected as a reward if starting at that node and following the best sequence of actions. The actions on the large lane graph may not be modeled as fully deterministic. In particular, a vehicle 700 may attempt a lane change or at least desire to make a lane change, but that lane change may be blocked by contending vehicles, forcing the vehicle to stay in its lane. At the last chance to make a lane change, the vehicle 700 may be blocked, causing the vehicle 700 to wait and not move forward in lane, instead ending up back at the same node.

As such, unlike a regular large lane graph, some edges are upgraded to an action that is attempted but may not succeed. And, instead of leading directly and deterministically to a certain node, the actions and edges may also, based on some probabilities, cause arrival at other nodes. Thus, lane planning is no longer simply based on determining shortest paths in the graph (e.g., with a deterministic graph, using—for example and without limitation—Dijkstra's algorithm to find the shortest paths and expected equivalent time from any node). Alternative algorithms that may be suitable include, without limitation, A*, Shortest Path, and Breadth-First algorithms and their variants. Instead, in the state and probabilistic action space, a value iteration method can be performed to find the best action and expected equivalent time from any node.

Finding the best action and expected equivalent can be performed efficiently based on initially executing a search algorithm (e.g., Dijkstra's search algorithm) on the graph. An assumption can be made that all actions will succeed and cause generation of an approximation of the expected equivalent time values at each node. The approximate expected equivalent times can be used as a starting point for performing value iteration on the probabilistic graph. In another embodiment, an additional technique can be implemented to make the value iteration faster. Operationally, a restriction is placed on a smaller scope of the large lane graph 130 to a scope that is close to a current position of the vehicle. This effectively creates one more levels in the planning hierarchy, leaving parts further out at regular graph search, locking the values of those nodes during the value iteration.

The large lane graph 130 may correspond to a portion of the lane planner input data, and may include information that is populated via the route planner 120—as described herein—and may optionally be augmented by live perception information (e.g., where there is feedback from the behavior planner 140 to update the large lane graph 130). The large lane graph 130 is processed at the lane planner 110 to generate lane planner output data that includes equivalent times 114 at a plurality of nodes of the large lane graph. With the equivalent times 114, the value of an action can be calculated as an expected value over the probabilistic outcomes of that action into the next node. Lane planner output data can further include a probability associated with an action that indicates a best action from each node. It is further contemplated that a single nominal plan can be generated—for example as a visualization or for cueing the motion planner—by assuming that the actions will succeed.

Lane planner output data (e.g., a lane plan) can be used to make determinations for lane changes. For example, let us assume that a particular lane is a preferred lane (e.g., peeling off other lanes). In such an example, the lane plan output data may indicate to change into that lane as soon as possible given otherwise equivalent parallel lanes. In practice, the closer a vehicle gets to the peel off point, the higher the risk that the lane change does not succeed in time. Thus, the closer the vehicle gets to the peel off point, the higher the pressure and this is reflected in expected equivalent times of the nodes. On the other hand, that target lane may be disadvantaged in some way, reflected, for example, in higher risks of forks or merges out of that lane—penalized by collision risks in the equivalent time of those edges—or reflected in higher equivalent times due to that lane moving slower. In this case, the lane plan may indicate to delay the lane change or to go around slower moving traffic before changing to the target lane. Moreover, the higher density and speed of vehicles may lower a likelihood of success for lane changes into a lane, now or in the future. This may be reflected by live perception informing the editing of lane change edges. In embodiments, higher speed or absence of vehicles may advantage one lane (or the nodes thereof) over another lane, which may be reflected by live perception informing the editing of lane keep edges. In some example, the closest set of edges may be edited by the behavior planner based on their immediate feasibility.

As such, the lane planner 110 receives the lane planner input data 112 and generates lane planner output data (e.g., lane planner output data 114 of FIG. 1A). The lane planner output data 114 includes expected equivalent time rewards (e.g., expected equivalent time rewards 114 in FIG. 1A) as discussed herein. The state and probabilistic action space facilitates executing a value iteration (e.g., via value iteration engine 110 of FIG. 1A) to find the best action and an expected equivalent time reward of any large lane graph node. The lane planner 110 generates lane guidance data: an expected equivalent time reward for each large lane graph node. Computing the expected equivalent time reward can include determining an action having a probability score that indicates a likelihood of executing the action. As such, instead of modelling actions that lead directly and deterministically to a certain node, the actions may also, based on other probabilities, allow the vehicle to arrive at a different node.

As such, operationally, and with respect to FIG. 1C, at C112, data representative of at least a portion of a lane graph 130 associated with a driving route of a vehicle is received. The large lane graph 130 includes a plurality of nodes indicative of potential locations within one or more lanes (e.g., local lanes) of the large lane graph 130 and a plurality edges connecting the plurality of nodes, each edge of the plurality of edges corresponding to a respective vehicle action of the vehicle within one or more lanes. For each edge of the plurality of edges, a cost function is computed based at least in part on an expected equivalent time 114 for traversing between the starting node and a connected node. Based at least in part on the one or more lanes, candidate vehicle action and one or more driving routes for each candidate vehicle action may be generated. Based at least in part on the cost function associated with each edge, an expected equivalent time reward is computed for each node, so that a determination of a driving route is made. The vehicle is controlled along the driving route. At C114, lane planner 110 provides lane planner output data to cause determination (e.g., via the behavior planner 140) of an identified action to be performed by the vehicle on the driving route.

With reference to FIGS. 2B-2F, FIGS. 2B-2F illustrate features of a large lane graph 130. The large lane graph 130 includes positions of driving lanes (e.g., lane 202B, lane 204B, and lane 206B of FIG. 2B). The large lane graph 130 can be a directed graph having nodes (e.g., node 202C, node 204C, and node 206C of FIG. 2C) that are positions of driving lanes. The positions can be sampled from lane representations in the map associated with the drive plan. The directed graph can further include edges (e.g., edge 202D and action 208D, edge 204D and action 210D, and edge 206D and action 212D) that connect two nodes and describe actions. Actions can include any of the following: straight, left lane turn, right lane change, etc. (e.g., action 208D, action 210D, and action 212D, respectively).

The lane planner input data can include a state and probabilistic action space associated with the large lane graph 130 (e.g., a directed graph) with nodes and edges corresponding to states and actions for at least a subsection of a map of a driving route. The state and probabilistic space also supports representing the expected equivalent time rewards 114 for the nodes. An expected equivalent time reward 114 can refer to a quantified time reward or cost for a completing the drive route.

The lane planner 110 operates as a planning component in the driving system having a hierarchical planning framework. The lane planner 110 provides operations to generate lane planner output data which may include data generated at the lane planner 110 to support determining an action to be performed by a vehicle on a driving route. The lane planner output data can be referred to as lane guidance or lane guidance data that is communicated to downstream components (e.g., a behavior planner 140). It is contemplated that the large lane graph nodes with equivalent reward times 114 may be linked with a local lane graph (e.g., generated from the same map that was used to build the large lane graph or from other sources such as live path perception) to support motion planning. The lane guidance data can identify lanes on which a vehicle should drive in order to complete a drive plan (e.g., a drive route or drive mission towards a target).

With reference to FIG. 2E, operationally, the lane planner output data may be generated based on reinforcement learning. Reinforcement learning can be implemented using a Markov Decision Process (“MDP”) that is associated with a collection of states and a collection of actions (e.g., state and probabilistic actions in FIG. 2E). Each action brings an existing state to a random output state, which triggers an equivalent expected time cost. As part of the reinforcement learning, the large lane graph 130 can be transformed into an MDP, where a large lane graph node represents a state, and a large lane graph edge represents an action with random output nodes. Negative edge costs are represented as rewards. The expected time reward 114 may refer to the optimal expected value, and each large lane graph node can be assigned an expected equivalent time reward (e.g., expected equivalent time rewards 114 of FIG. 1A). The expected equivalent time reward of a node measures, in terms of time, how good it is to arrive at the target starting from this node. An expected equivalent time reward 114 may refer to, for a driving route, a time a driver is willing to spend minus an expected equivalent time cost.

With reference to FIG. 2F, an edge of the large lane graph 130 indicating a left lane change action can be created. The edge can begin at a large lane graph node positioned at location 202F, and end at two possible large lane graph nodes, one positioned at location 204F and the other one positioned at location 206F. If the edge ends at location 204F the left lane change is successful. If the lane change fails, the vehicle at location 202F may not pass the lane divider, may return to its original lane and may end up at location 206F. An expected equivalent time cost is assigned to every large lane graph edge, and the expected equivalent time cost can be based on a length of a lane in the map and a map speed (e.g., a detected speed at which the vehicle is moving, labeled in a map). The cost of each edge can be further adjusted based on the action type. For example, additional cost can be incurred for a lane change.

The MDP (FIG. 2E) used in the lane planner 110 can also include actions with probability distributions. For example, each action encoded in a large lane graph edge may have a probability of failure (e.g., lane change success probability, PROB 0.9 of location 204F and lane change failure probability, PROB. 0.1 of location 206F of FIG. 2F). The target node of an edge can be identified at random (e.g., location 204F or location 206F). Unlike conventional systems, expected equivalent time rewards 114 in this technical solution are based on optimal expected values of time rewards and further take into account future uncertainty.

With reference to FIG. 2G, operationally, the expected equivalent time rewards 114 can be calculated more efficiently by initially using a search algorithm (e.g., Djikstra's algorithm) to identify time costs from a source node to any large lane graph node. The time costs can be used in a value iteration or variants of the value iteration (e.g., via value iteration engine 118 of FIG. 1A) to calculate the expected equivalent time rewards 114. Expected equivalent time rewards can be represented in a heat map rendering. The heat map rendering is a visualization used to depict the intensity (e.g., high, med, low) of expected equivalent time rewards data. For example, the heatmap (e.g., heatmap in FIG. 2G with source node 202G, target node 204G, first color dimension 206G, second color dimension 208G, and third color dimension 210G) can be enabled with a colored overlay that will appear on the map, and areas with higher expected equivalent time rewards will be colored in a first color and areas in with lower expected equivalent time rewards will be appear in a second color. A third color (e.g., a mix of the first color and second color) can depict medium expected equivalent time rewards. In this way, the heatmap can provide obvious visual cues to a viewer about how the expected equivalent time reward is clustered or varies over space. For example, the nodes with higher expected time rewards are often close to the target node; the nodes with lower expected time rewards are often close to the source node; mission failure nodes (e.g., nodes that do not have paths connected to the target node) have zero expected time rewards.

Modified Value Iteration

The expected equivalent time reward 114 as defined as an optimal expected value can be generated based on value iteration; however, a modified value iteration method can be used instead to control the number of iterations. At a high level, because large lane graphs are generally cyclic, with the classical value iteration, the number of iterations is uncontrolled (e.g., the classical value iteration may perform a large number of iterations until convergence)—so the computation can be expensive. In contrast, the modified value iteration method breaks the cycles of a large lane graph, so the large lane graph 130 becomes acyclic, and an order of nodes can be created so that that the expected time rewards can be propagated fast towards the source node. Therefore, one iteration of the modified value iteration method via this order can return sufficiently good results. In situations where the lane planner evaluates nodes that do not have positive expected time rewards because the edges coming from the nodes have been eliminated, the edges can be added back and the node rewards can be updated.

For example, in the state and probabilistic action space (represented by the large lane graph 130), a value iteration method can be performed to find the best action and expected equivalent time reward 114 from any node. Variants of value iteration for computing expected time rewards of nodes in a large lane graph are described below. Calculating expected time rewards can be based on reinforcement learning. Operationally, a large lane graph 130 can be transformed into a Markov Decision Process (“MDP”), where the nodes of the large lane graph 130 are states and the edges of the large lane graph are actions. Each action a brings one state n to a random output state m, and the transition probability may be denoted by p(m|n, a).

In general, for any MDP, each state carries a value that measures a likelihood of being in the state. In the case of a large lane graph 130, the expected time reward 114 of a large lane graph node is a representation of the node's value. The value function can be computed via an iterative process called value iteration. At each iteration, the value of every node is updated according to the values of the other nodes that the node depends on. In theory, after sufficient iterations, the value of the node becomes a constant which is the expected time reward. In the case that the large lane graph is acyclic, one iteration is sufficient because computations can be performed for a given order of nodes to compute the values, so that any additional iterations will not modify the values.

Large lane graphs are in general cyclic and if the number of iterations is uncontrolled the computation can be very expensive. However, the large lane graph 130 can be processed (e.g., breaking cycles) so the large lane graph becomes acyclic, at the same time, the node order that ensures the best propagation of values is computed. Therefore, one iteration via this order can return sufficiently good results. If some nodes do not have positive expected time rewards because the edges coming from these nodes are gone, the edges can be added back and the rewards for these nodes can be updated.

In operation, suppose that one source node and one multiple target nodes are identified from a large lane graph 130. At operation 1: for each large lane graph node, a reset operation is performed to set an expected time reward (e.g., reward attribute) of the node to be zero, set a state (e.g., a state attribute) of the node to be unsettled, and a set a dependency count (e.g., a dependency count attribute) which is the number of unsettled immediate successors.

At operation 2: A search algorithm (e.g., Dijkstra's algorithm) operation is run using a binary heap on the deterministic large lane graph (e.g., the large lane graph that assumes all actions in it are successful). Using the heap, an order of large lane graph nodes may be computed based on the descending order of costs from the source node. An array of this node order (e.g., NodeOrder) is generated.

At operation 3: An empty queue (“Queue”), a first empty array (e.g., SettleOrder) storing nodes, and a second empty array (e.g., RemovedEdges) are initialized. In one or more embodiments, the first empty array may be used to store nodes and the second empty array may be used to store the edges that will be removed, and any node in the SettleOrder array may be a settled node. The lane planner process works on the NodeOrder array, the Queue, the SettleOrder array, and the RemovedEdges array.

At operation 4: The SettleOrder array is built and the expected time rewards of its nodes are computed. For example, for each computation where a node is pushed into the Queue, the node becomes a settled node, then the dependency counts of all immediate predecessor nodes of this node are updated. Determining that the stopping criterion has been met is based on performing an operation 4a followed by an operation 4b, described below. In one or more embodiments, one or more operations 4a and 4b may be performed repeatedly until a stopping criterion is met.

At operation 4a, one out of the following three operations may be performed. A first operation includes pushing the target node into the Queue, a second operation includes pushing the nodes with zero dependency counts into the Queue provided that the target node is settled, and a third operation includes, if the nodes mentioned in the first operation and in the second operation are settled, performing another operation(s). The third operation of operation 4a may include one or more of traversing the array NodeOrder to get a large lane graph edge that ends at an unsettled node in the NodeOrder array, ignoring all nodes in the NodeOrder array before this ending node, or removing the edge from the large lane graph and updating the dependency count of the starting node of this edge. If its dependency count is zero, the node is pushed into the Queue and this removed edge is saved in the RemovedEdges array.

At operation 4b, one or more operations may be performed repeatedly until the Queue is empty. For example, these operations of operation 4b may include popping the front node of Queue, pushing this node into the SettleOrder array and computing the expected time reward of this node, or looking up immediate predecessors of this node and pushing unsettled nodes with zero dependency counts into the Queue.

At operation 5, all edges in the RemovedEdges array may be added back to the large lane graph and the expected time rewards may be updated based on the SettleOrder array, for any selected number of iterations.

Other considerations with reference to the algorithm include: for the stopping criterion in operation 4, the stopping criterion can be any other reasonably defined criterion, for example, source node is settled, nodes near the source node are settled, and/or every large lane graph node is settled. Operation 4 can be defined to require looking up the immediate predecessors of a large lane graph node and, for a more efficient implementation, the information for every large lane graph node can be cached beforehand.

Expected time rewards 114 can be computed as follows: for each target node, the reward is a determined positive value (e.g., a fixed large positive value, a value derived from the expected equivalent time reward of a guiding target computed by a route planner); for nodes that do not have any immediate successors, the reward is zero; and for the other nodes, the reward of a node n, Reward(n), can be computed via the Bellman equation, below:

$$Reward ( n ) = {max}_{\{ actions a from n \}} Reward ( a )$$

where

Reward(a)=Σ_({output nodes m}) [symbol] [symbol] p(m|n,a)[Reward(m)−ActionCost(a,n→m)]

[symbol]

where p(m|n, a) is the transition probability that carries a node n to m via action a, and ActionCost(a, n→m) is the cost of taking the action a that carries n to m. Note that an assumed discount rate is set to one.

An assumption can be made that the expected time reward 114 of every target node is large enough, and when a node has a positive reward, it means there is a path from this node to at least one of the target nodes. Otherwise there is no such path.

For the time complexity of the algorithm, N and E can be the number of large lane graph nodes and edges, respectively. Overall, the complexity is linear in the large lane graph nodes and edges excluding that of the Dijkstra algorithm. In particular, operation 2 takes O(E log N). For operation 4, creating the SettleOrder array takes O(N+E) and the reward computation takes O(N+E). Operation 5 takes O(N+E), as the number of iterations is a fixed parameter.

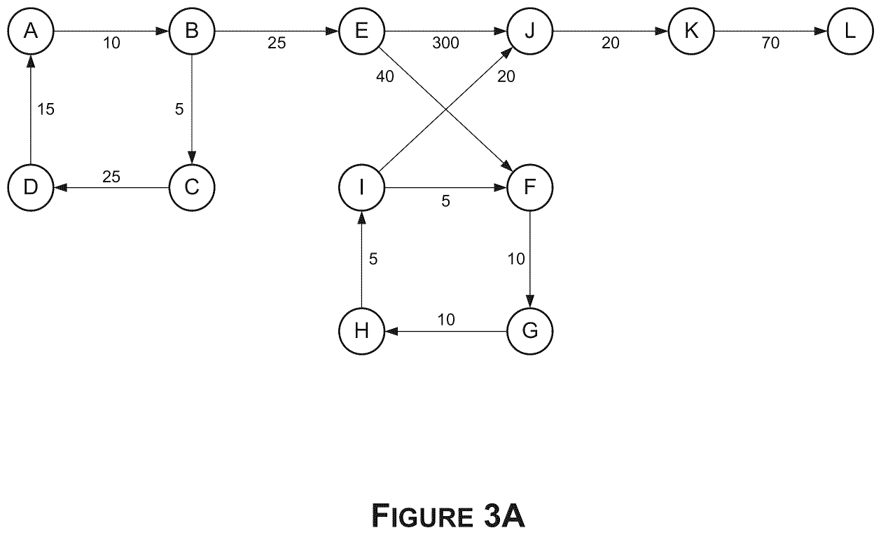

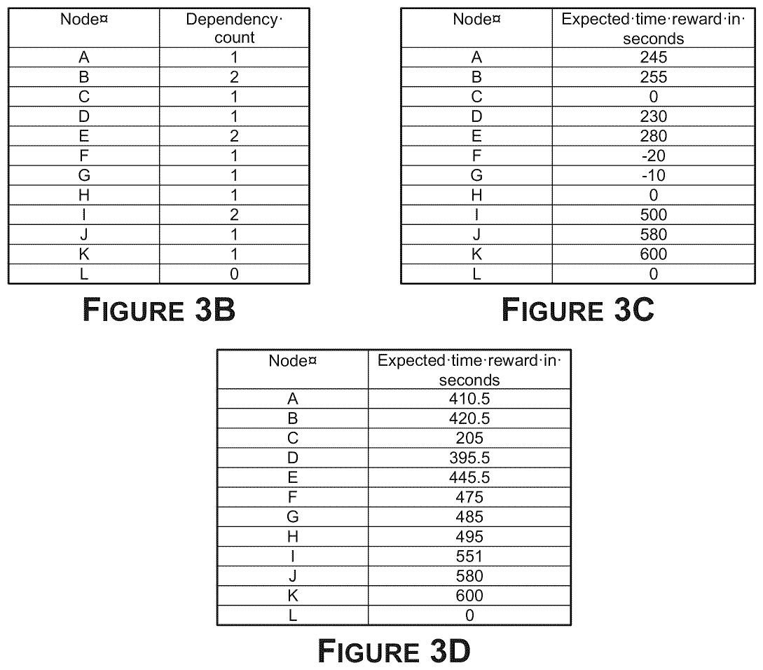

With reference to FIGS. 3A-3D, an example illustration of a modified value iteration method is provided. The numbers in the diagram indicate the edge costs in seconds. The source node is A and the target node is K. The edges EF and IJ represent two actions that may fail. If the action EF fails, the output becomes J instead of F. If the action IJ fails, the output becomes F instead of J. The probability for EF or IJ to succeed is 0.9. The cost of taking the failed action is the same as that of the successful action. Any edge other than EF and IJ is always successful. In this example, the word “reward” means the expected equivalent time reward.

Performing the modified value iteration method includes the following operations: Operation 1: An initial configuration is made such that all nodes are not settled and carry zero rewards. The dependency counts are shown in FIG. 3B. Operation 2: On the deterministic large lane graph 130 (that assumes actions EF and IJ will not fail), a search algorithm (e.g., Dijkstra algorithm) is executed to get the NodeOrder array based on the descending order of costs from A: NodeOrder=[L, K, J, I, H, G, F, D, E, C, B, A]. Operation 3: The stopping criterion corresponds to when all large lane graph nodes are settled.

Operationally, at a first operation, the target node K is pushed into the Queue. Pushing the target node into the Queue reduces the dependency count of the target node K's immediate predecessor J by one. As such, node J has zero dependency count, and the Queue=[K]. At a second step, only the node K is popped from the Queue and then K is pushed into the SettleOrder array. Since K is the target node, its expected time reward 114 can be set to be a large fixed constant, say 600 seconds.

Node J is the only immediate predecessor of K. It has zero dependency count, thus can be pushed into the Queue. Thus the Queue=[J]. The dependency counts of E and I become one. And then, only node J is popped from the Queue and J is pushed into the SettleOrder array. This results in:

Reward(J)=Reward(K)−ActionCost(JK)=600-20=580,

### and SettleOrder=[K, J].

Since the dependency counts of E and I are not zero, they are not pushed into the Queue. The Queue is empty. Now, node L is the only node with zero dependency count, so L is pushed into the Queue. L is then popped from the Queue, and pushed into the SettleOrder array. The reward of L is zero. All immediate predecessors of L are settled, and the Queue is empty again, with SettleOrder=[K, J, L].

The modified value iteration method further includes removing one edge from the graph. The NodeOrder array is then checked. The edges pointing to settled nodes K, J, L are not removed, but any edge pointing to the unsettled node I can be removed. Thus, the method also includes removing the edge HI.

Next, node H's dependency count becomes zero, so it can be pushed into the Queue. Carrying on the process until node E is settled, a SettleOrder=[K, J, L, H, G, F, I, E] is attained, the Queue is empty, and the rewards of H, G, F are 0, −10, −20, respectively. There are two actions starting at I, IJ, and IF. The action IF is always successful, so it has a reward −25. The reward of IJ is:

0.9(Reward(J)−20)+0.1(Reward(F)−20)=500.

This means Reward(I)=500 (maximum of 500 and −25).

Similarly, Reward(E)=280. The dependency count of B is one. From the NodeOrder array, at this operation, the edge CD is removed. This ensures nodes C and B are settled with rewards 0 and 255, respectively. Nodes A and D are settled with rewards 245 and 230, respectively. All nodes are settled so Operation 4 ends. Summing up Operation 4, the SettleOrder array is [K, J, L, H, G, F, I, E, C, B, A, D], two edges HI and CD are removed, and the node rewards are as shown in FIG. 3C.

At Operation 5, the edges HI and CD are added back to the graph, using the SettleOrder array to update the rewards of every node one more time, and computing the result shown in FIG. 3D. Except L, all nodes carry positive rewards. It implies for any node other than L, there is a path to travel from this node to the target node K.

Behavior Planner

Turning to the behavior planner 140, the behavior planner 140 plans more immediate behaviors. Behavior can include any of the following: motion to accomplish lane keeping, motion to accomplish a lane change, motion to turn, motion to fork, or motion to merge. The motion can be defined for fixed period of time or a defined for a fixed distance. Operationally, a world model output can be used for obstacles, paths, and wait conditions to handle those optimization categories as rewards. For example, the behavior planner 140 may use a model for how jerky motion affects comfort—and how jerky motion plans carries an expected comfort penalty in terms of equivalent time. The behavior planner 140 may also use the expected equivalent times of upcoming nodes to consider progress towards the target reward, and may discount for time and resources spent to reach nodes near it. The behavior planner 140 operates to reach nodes in close proximity—with higher expected reward than the current node closer to the target—with less time spent.

The behavior planner 140 interfaces with the lane planner to support behavior planning. Operationally, the behavior planner 140 receives lane planner output data that includes the expected equivalent time rewards 114 of the nodes of the large lane graph 130, and includes linking nodes to more precise local geometry and immediate actions in the behavior planning. The behavior planner 140 can operate with a more detailed lane graph in the data structures (e.g., a local lane graph) defined by the local world model that are linked to the large lane graph 130. The local lane graph (e.g., a map-based local lane graph) may be generated from the same underlying map data that was used to create the large lane graph 130. This allows the links between nodes of the large lane graph 130 and lane segments in the map-based local lane graph to be exactly known. The map-based local lane graph can be generated through precise localization, such that the local lane graph includes precise geometry for any plan given the lane planner output data. In this way, the lane planner output data can be turned into, e.g., lane change or forking instructions.

The lane planner output data can also be used to perform matching in turn to any other local lane graphs such as the ones generated purely by live perception. Through those links, any lane graph used for driving may be associated with expected equivalent times from the lane planner output data. Moreover, the geometry of the lane planner output data may be used to match to live perception, and the geometry is more flexible than a fixed set of lane names—such as fork left or fork right—which can break down if it is a three-way fork. As such, the lane planner output data can be used to generate a precise geometry of a lane graph that is used for detailed motion planning, with associated expected equivalent times at vertices with regular spacing along the lane centers.

The behavior planner 140 can be configured to create one or more layers of the planning hierarchy in a similar manner to previous layers, by fixing the expected equivalent times at some close nodes and considering them as target nodes. A motion planner 142 of the behavior planner is then applied for a number of possible actions—such as lane keep, lane change, lane change abort, turn, etc. Operationally, for each action, the motion planner tests a number of motion plans and evaluates them for cost and reward terms. Obstacles may be handled by considering a safety system or set of safety protocols and guidelines (such as the Safety Force Field developed by NVIDIA corporation) as a hard constraint and/or by paying penalties (e.g., for jerkiness). Paths may be handled by penalizing deviations from the lane center, and wait conditions may be handled as boundary constraints on longitudinal progress in addition to yielding constraints. Progress may be handled by subtracting the time and resources spent from the expected equivalent time of the nodes we reach, and/or comfort can be encouraged by penalizing jerky motion plans. As such, motion plans from different actions can in principle be compared on common grounds for their merit and can be used as a basis for, e.g., whether a motion plan from a lane change or lane keep action is chosen.

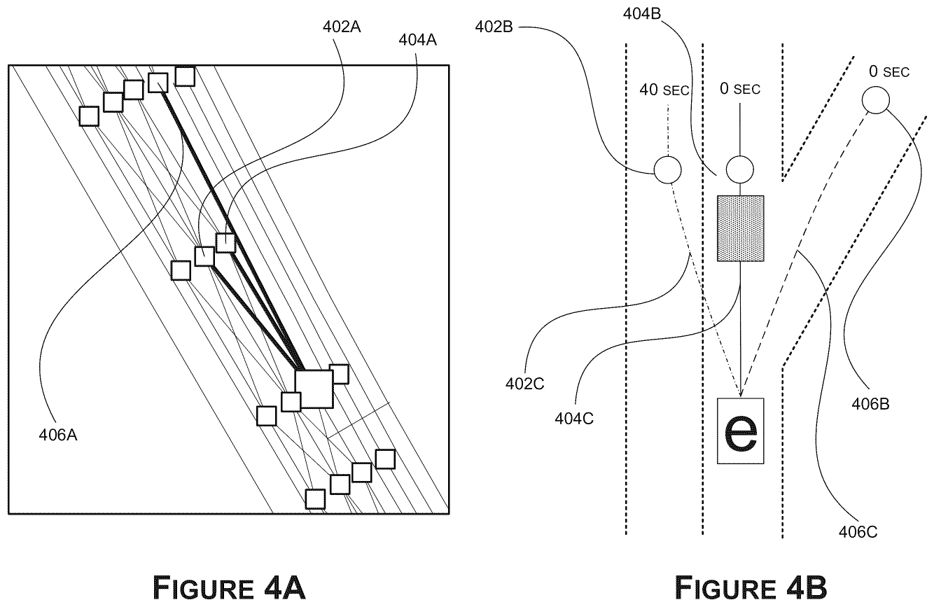

With reference to behavior planner 140 in FIG. 1C, lane planner output data can be used in a behavior planner 140 (e.g., via the motion planner in FIG. 1A), for example, for selecting a lane to drive on. At C142, the behavior planner 140 operates to process lane planner output data to determine an identified action to be performed by a vehicle on a driving route. In this way, the behavior planner 140 can support making a lane selection for a plurality of lanes. The behavior planner 140 receives a plurality of local lanes (e.g., lane 402C, lane 404C, and lane 406C, in FIG. 4A-4B) and generates candidate vehicle actions and the corresponding driving routes (e.g., lane 402C corresponds to a left lane change, lane 404C corresponds to driving straight, and lane 406C corresponds to taking the right fork). The lane planner 110 provides expected equivalent time rewards of large lane graph nodes linked to the local world map lanes. The behavior planner 140 identifies the plurality of lanes and understands their connections in the map. Then, behavior planner 140 receives the assignment (e.g., large lane graph nodes with local lane positions 144 in FIG. 1B) of a node (e.g., node 402A, node 404A, and node 406A) in the large lane graph 130 to each of the plurality of lanes (e.g., corresponding to node 402B, node 404B, and node 406B respectively). Such an assignment is possible, because the local lanes may be generated from the same underlying map data that was used to create the large lane graph 130. If the local lanes are generated by other methods, such as the ones generated purely by live perception, a matching can be performed between the map-based lanes and the live-perceived lanes, so that large lane graph nodes can be assigned to the live-perceived lanes. Assigning the nodes to the plurality lanes is performed in order to derive an expected equivalent time reward of each of the plurality of lanes, and the expected equivalent time reward 114 (e.g., 40 secs, 0 secs, 0 secs) can be the node expected equivalent time reward 114 minus the equivalent time cost between the current vehicle location (the box with a letter e in FIG. 4B) and the node, truncated at zero seconds. The equivalent time cost between the current vehicle location and a node can be determined based on local live perception that lane planner 110 does not consider. For example, the vehicle lane 404C has zero expected equivalent time reward because the stationary obstacle right in front of the vehicle is blocking the vehicle to drive forward (or make progress), even the expected time reward at node 404B is positive by the lane planner 110. As such, the behavior planner 140 selects the vehicle action that maximizes the expected time reward, controls a vehicle along a driving route based at least in part on a vehicle action. In this example, the vehicle may perform a left lane change (e.g., select lane 402C) because the lane on the left of the vehicle's lane 402C has the highest expected equivalent time reward.

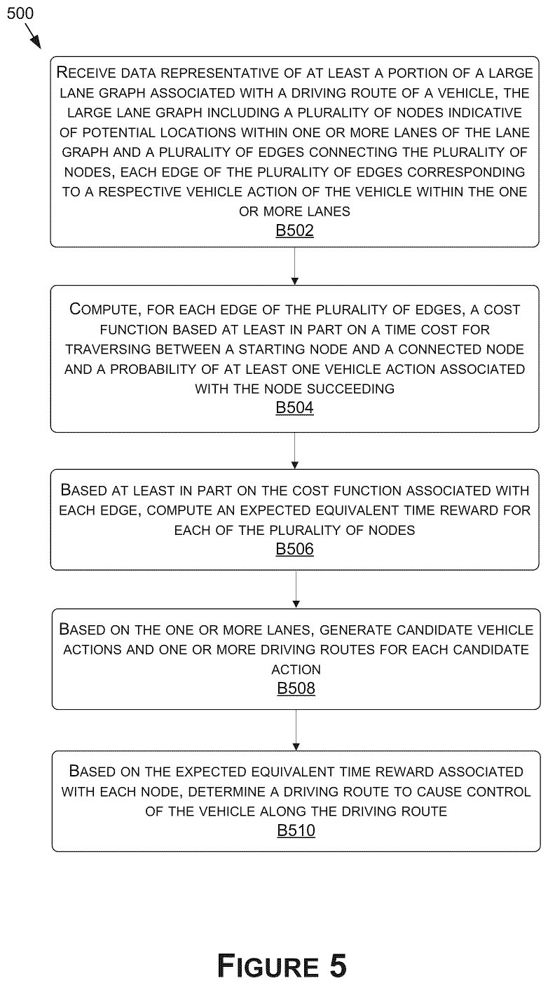

Now referring to FIG. 5, each block of method 500, described herein, comprises a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a service or hosted service (standalone or in combination with another hosted service), or a plug-in to another product, to name a few. In addition, method 500 is described, by way of example, with respect to the system 100 of FIG. 1. However, these methods may additionally or alternatively be executed by any one system, or any combination of systems, including, but not limited to, those described herein. However, these methods may additionally or alternatively be executed by any one system, or any combination of systems, including, but not limited to, those described herein.

FIG. 5 is a flow diagram showing a method 500 for operating a lane planner to generate lane planner output data, in accordance with some embodiments of the present disclosure. The method 500, at block B502, includes receiving data representative of at least a portion of a lane graph associated with a driving route of a vehicle. The large lane graph includes a plurality of nodes indicative of potential locations within one or more lanes of the large lane graph and a plurality of edges connecting the plurality of nodes. As depicted for clarity, each edge of the plurality of edges corresponds to a respective vehicle action of the vehicle within the one or more lanes (i.e., local lanes). The large lane graph is a directed graph data structure comprising at least the plurality of nodes including target nodes and source nodes. The plurality of nodes, and the plurality of edges corresponding to actions that define a state and action space for determining the driving route.

The method 500, at block B504, includes computing, for each, edge of the plurality of edges corresponding to a vehicle action, a cost function based at least in part on a time cost for traversing between the starting node and a connection node of the starting node and a probability of a vehicle action associated with the node succeeding. In one or more embodiments, such computation can be performed for each of the plurality of edges. The method 500, at block 506, includes computing the expected time reward for each node in the plurality of nodes is based at least in part on executing a modified value iteration that controls the number of iterations for executing the modified value iteration operation that computes the expected equivalent time rewards. Controlling the number of iterations for executing the modified value iteration operation is based on at least one stopping criteria.

The method 500, at block B508, includes, based at least in part on the one or more lanes, generate candidate vehicle actions and one or more driving routes for each candidate vehicle action. The method 500, at block 510, includes based at least in part on the expected equivalent time reward associated with each node, determine the driving route to cause controlling the vehicle along the driving route

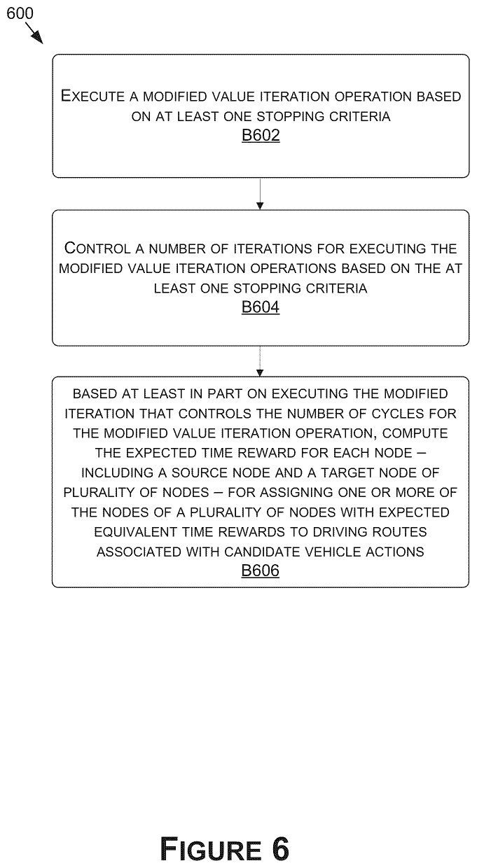

With reference now to FIG. 6, FIG. 6 is a flow diagram showing a method 600 for operating a driving system to provide lane planner output data for drive planning in accordance with some embodiments of the present disclosure. The method 600, at block B602, includes executing a modified value iteration operation based on at least one stopping criteria. The method 600, at block B604, includes controlling a number of iterations for executing the modified value iteration operations based on at the least one stopping criteria. The method 600, at block B606, includes computing the expected time reward for each node of a plurality of nodes including a source node and a target node of the plurality of nodes based at least in part on executing the modified value iteration that controls the number of iterations for the modified value iteration, and assigning one or more of the plurality node nodes with expected time equivalent time rewards to driving routes associated with candidate vehicle actions. The expected equivalent time cost of each edge of a plurality of edges associated with the plurality of nodes is based at least in part on a time cost for traversing between a starting node and a connected node for the node and a probability of a vehicle action associated with the node succeeding. Moreover, the expected equivalent time reward for each node is updated at each iteration of a plurality of iterations.

Example Autonomous Vehicle

FIG. 7A is an illustration of an example autonomous vehicle 700, in accordance with some embodiments of the present disclosure. The autonomous vehicle 700 (alternatively referred to herein as the “vehicle 700”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a drone, a vehicle coupled to a trailer, and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 700 may be capable of functionality in accordance with one or more of Level 3-Level 5 of the autonomous driving levels. The vehicle 700 may be capable of functionality in accordance with one or more of Level 1-Level 5 of the autonomous driving levels. For example, the vehicle 700 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 700 or other machine, such as being fully autonomous, being highly autonomous, being conditionally autonomous, being partially autonomous, providing assistive autonomy, being semi-autonomous, being primarily autonomous, or other designation.

The vehicle 700 may include components such as a chassis, a vehicle body, wheels (e.g., 2, 4, 6, 8, 18, etc.), tires, axles, and other components of a vehicle. The vehicle 700 may include a propulsion system 750, such as an internal combustion engine, hybrid electric power plant, an all-electric engine, and/or another propulsion system type. The propulsion system 750 may be connected to a drive train of the vehicle 700, which may include a transmission, to enable the propulsion of the vehicle 700. The propulsion system 750 may be controlled in response to receiving signals from the throttle/accelerator 752.

A steering system 754, which may include a steering wheel, may be used to steer the vehicle 700 (e.g., along a desired path or route) when the propulsion system 750 is operating (e.g., when the vehicle is in motion). The steering system 754 may receive signals from a steering actuator 756. The steering wheel may be optional for full automation (Level 5) functionality.

The brake sensor system 746 may be used to operate the vehicle brakes in response to receiving signals from the brake actuators 748 and/or brake sensors.

Controller(s) 736, which may include one or more system on chips (SoCs) 704 (FIG. 7C) and/or GPU(s), may provide signals (e.g., representative of commands) to one or more components and/or systems of the vehicle 700. For example, the controller(s) may send signals to operate the vehicle brakes via one or more brake actuators 748, to operate the steering system 754 via one or more steering actuators 756, to operate the propulsion system 750 via one or more throttle/accelerators 752. The controller(s) 736 may include one or more onboard (e.g., integrated) computing devices (e.g., supercomputers) that process sensor signals, and output operation commands (e.g., signals representing commands) to enable autonomous driving and/or to assist a human driver in driving the vehicle 700. The controller(s) 736 may include a first controller 736 for autonomous driving functions, a second controller 736 for functional safety functions, a third controller 736 for artificial intelligence functionality (e.g., computer vision), a fourth controller 736 for infotainment functionality, a fifth controller 736 for redundancy in emergency conditions, and/or other controllers. In some examples, a single controller 736 may handle two or more of the above functionalities, two or more controllers 736 may handle a single functionality, and/or any combination thereof.

The controller(s) 736 may provide the signals for controlling one or more components and/or systems of the vehicle 700 in response to sensor data received from one or more sensors (e.g., sensor inputs). The sensor data may be received from, for example and without limitation, global navigation satellite systems sensor(s) 758 (e.g., Global Positioning System sensor(s)), RADAR sensor(s) 760, ultrasonic sensor(s) 762, LIDAR sensor(s) 764, inertial measurement unit (IMU) sensor(s) 766 (e.g., accelerometer(s), gyroscope(s), magnetic compass(es), magnetometer(s), etc.), microphone(s) 796, stereo camera(s) 768, wide-view camera(s) 770 (e.g., fisheye cameras), infrared camera(s) 772, surround camera(s) 774 (e.g., 360 degree cameras), long-range and/or mid-range camera(s) 798, speed sensor(s) 744 (e.g., for measuring the speed of the vehicle 700), vibration sensor(s) 742, steering sensor(s) 740, brake sensor(s) (e.g., as part of the brake sensor system 746), and/or other sensor types.

One or more of the controller(s) 736 may receive inputs (e.g., represented by input data) from an instrument cluster 732 of the vehicle 700 and provide outputs (e.g., represented by output data, display data, etc.) via a human-machine interface (HMI) display 734, an audible annunciator, a loudspeaker, and/or via other components of the vehicle 700. The outputs may include information such as vehicle velocity, speed, time, map data (e.g., the HD map 722 of FIG. 7C), location data (e.g., the vehicle's 700 location, such as on a map), direction, location of other vehicles (e.g., an occupancy grid), information about objects and status of objects as perceived by the controller(s) 736, etc. For example, the HMI display 734 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The vehicle 700 further includes a network interface 724 which may use one or more wireless antenna(s) 726 and/or modem(s) to communicate over one or more networks. For example, the network interface 724 may be capable of communication over LTE, WCDMA, UMTS, GSM, CDMA2000, etc. The wireless antenna(s) 726 may also enable communication between objects in the environment (e.g., vehicles, mobile devices, etc.), using local area network(s), such as Bluetooth, Bluetooth LE, Z-Wave, ZigBee, etc., and/or low power wide-area network(s) (LPWANs), such as LoRaWAN, SigFox, etc.

FIG. 7B is an example of camera locations and fields of view for the example autonomous vehicle 700 of FIG. 7A, in accordance with some embodiments of the present disclosure. The cameras and respective fields of view are one example embodiment and are not intended to be limiting. For example, additional and/or alternative cameras may be included and/or the cameras may be located at different locations on the vehicle 700.

The camera types for the cameras may include, but are not limited to, digital cameras that may be adapted for use with the components and/or systems of the vehicle 700. The camera(s) may operate at automotive safety integrity level (ASIL) B and/or at another ASIL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom designed (3-D printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3-D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 700 (e.g., front-facing cameras) may be used for surround view, to help identify forward facing paths and obstacles, as well aid in, with the help of one or more controllers 736 and/or control SoCs, providing information critical to generating an occupancy grid and/or determining the preferred vehicle paths. Front-facing cameras may be used to perform many of the same ADAS functions as LIDAR, including emergency braking, pedestrian detection, and collision avoidance. Front-facing cameras may also be used for ADAS functions and systems including Lane Departure Warnings (LDW), Autonomous Cruise Control (ACC), and/or other functions such as traffic sign recognition.

A variety of cameras may be used in a front-facing configuration, including, for example, a monocular camera platform that includes a CMOS (complementary metal oxide semiconductor) color imager. Another example may be a wide-view camera(s) 770 that may be used to perceive objects coming into view from the periphery (e.g., pedestrians, crossing traffic or bicycles). Although only one wide-view camera is illustrated in FIG. 7B, there may any number of wide-view cameras 770 on the vehicle 700. In addition, long-range camera(s) 798 (e.g., a long-view stereo camera pair) may be used for depth-based object detection, especially for objects for which a neural network has not yet been trained. The long-range camera(s) 798 may also be used for object detection and classification, as well as basic object tracking.

One or more stereo cameras 768 may also be included in a front-facing configuration. The stereo camera(s) 768 may include an integrated control unit comprising a scalable processing unit, which may provide a programmable logic (FPGA) and a multi-core micro-processor with an integrated CAN or Ethernet interface on a single chip. Such a unit may be used to generate a 3-D map of the vehicle's environment, including a distance estimate for all the points in the image. An alternative stereo camera(s) 768 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 768 may be used in addition to, or alternatively from, those described herein.

Cameras with a field of view that include portions of the environment to the side of the vehicle 700 (e.g., side-view cameras) may be used for surround view, providing information used to create and update the occupancy grid, as well as to generate side impact collision warnings. For example, surround camera(s) 774 (e.g., four surround cameras 774 as illustrated in FIG. 7B) may be positioned to on the vehicle 700. The surround camera(s) 774 may include wide-view camera(s) 770, fisheye camera(s), 360 degree camera(s), and/or the like. Four example, four fisheye cameras may be positioned on the vehicle's front, rear, and sides. In an alternative arrangement, the vehicle may use three surround camera(s) 774 (e.g., left, right, and rear), and may leverage one or more other camera(s) (e.g., a forward-facing camera) as a fourth surround view camera.

Cameras with a field of view that include portions of the environment to the rear of the vehicle 700 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 798, stereo camera(s) 768), infrared camera(s) 772, etc.), as described herein.

FIG. 7C is a block diagram of an example system architecture for the example autonomous vehicle 700 of FIG. 7A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 700 in FIG. 7C are illustrated as being connected via bus 702. The bus 702 may include a Controller Area Network (CAN) data interface (alternatively referred to herein as a “CAN bus”). A CAN may be a network inside the vehicle 700 used to aid in control of various features and functionality of the vehicle 700, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 702 is described herein as being a CAN bus, this is not intended to be limiting. For example, in addition to, or alternatively from, the CAN bus, FlexRay and/or Ethernet may be used. Additionally, although a single line is used to represent the bus 702, this is not intended to be limiting. For example, there may be any number of busses 702, which may include one or more CAN busses, one or more FlexRay busses, one or more Ethernet busses, and/or one or more other types of busses using a different protocol. In some examples, two or more busses 702 may be used to perform different functions, and/or may be used for redundancy. For example, a first bus 702 may be used for collision avoidance functionality and a second bus 702 may be used for actuation control. In any example, each bus 702 may communicate with any of the components of the vehicle 700, and two or more busses 702 may communicate with the same components. In some examples, each SoC 704, each controller 736, and/or each computer within the vehicle may have access to the same input data (e.g., inputs from sensors of the vehicle 700), and may be connected to a common bus, such the CAN bus.

The vehicle 700 may include one or more controller(s) 736, such as those described herein with respect to FIG. 7A. The controller(s) 736 may be used for a variety of functions. The controller(s) 736 may be coupled to any of the various other components and systems of the vehicle 700, and may be used for control of the vehicle 700, artificial intelligence of the vehicle 700, infotainment for the vehicle 700, and/or the like.

The vehicle 700 may include a system(s) on a chip (SoC) 704. The SoC 704 may include CPU(s) 706, GPU(s) 708, processor(s) 710, cache(s) 712, accelerator(s) 714, data store(s) 716, and/or other components and features not illustrated. The SoC(s) 704 may be used to control the vehicle 700 in a variety of platforms and systems. For example, the SoC(s) 704 may be combined in a system (e.g., the system of the vehicle 700) with an HD map 722 which may obtain map refreshes and/or updates via a network interface 724 from one or more servers (e.g., server(s) 778 of FIG. 7D).

The CPU(s) 706 may include a CPU cluster or CPU complex (alternatively referred to herein as a “CCPLEX”). The CPU(s) 706 may include multiple cores and/or L2 caches. For example, in some embodiments, the CPU(s) 706 may include eight cores in a coherent multi-processor configuration. In some embodiments, the CPU(s) 706 may include four dual-core clusters where each cluster has a dedicated L2 cache (e.g., a 2 MB L2 cache). The CPU(s) 706 (e.g., the CCPLEX) may be configured to support simultaneous cluster operation enabling any combination of the clusters of the CPU(s) 706 to be active at any given time.

The CPU(s) 706 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 706 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 708 may include an integrated GPU (alternatively referred to herein as an “iGPU”). The GPU(s) 708 may be programmable and may be efficient for parallel workloads. The GPU(s) 708, in some examples, may use an enhanced tensor instruction set. The GPU(s) 708 may include one or more streaming microprocessors, where each streaming microprocessor may include an L1 cache (e.g., an L1 cache with at least 96 KB storage capacity), and two or more of the streaming microprocessors may share an L2 cache (e.g., an L2 cache with a 512 KB storage capacity). In some embodiments, the GPU(s) 708 may include at least eight streaming microprocessors. The GPU(s) 708 may use compute application programming interface(s) (API(s)). In addition, the GPU(s) 708 may use one or more parallel computing platforms and/or programming models (e.g., NVIDIA's CUDA).

The GPU(s) 708 may be power-optimized for best performance in automotive and embedded use cases. For example, the GPU(s) 708 may be fabricated on a Fin field-effect transistor (FinFET). However, this is not intended to be limiting and the GPU(s) 708 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread scheduling capability to enable finer-grain synchronization and cooperation between parallel threads. The streaming microprocessors may include a combined L1 data cache and shared memory unit in order to improve performance while simplifying programming.

The GPU(s) 708 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 708 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 708 to access the CPU(s) 706 page tables directly. In such examples, when the GPU(s) 708 memory management unit (MMU) experiences a miss, an address translation request may be transmitted to the CPU(s) 706. In response, the CPU(s) 706 may look in its page tables for the virtual-to-physical mapping for the address and transmits the translation back to the GPU(s) 708. As such, unified memory technology may allow a single unified virtual address space for memory of both the CPU(s) 706 and the GPU(s) 708, thereby simplifying the GPU(s) 708 programming and porting of applications to the GPU(s) 708.

In addition, the GPU(s) 708 may include an access counter that may keep track of the frequency of access of the GPU(s) 708 to memory of other processors. The access counter may help ensure that memory pages are moved to the physical memory of the processor that is accessing the pages most frequently.

The SoC(s) 704 may include any number of cache(s) 712, including those described herein. For example, the cache(s) 712 may include an L3 cache that is available to both the CPU(s) 706 and the GPU(s) 708 (e.g., that is connected both the CPU(s) 706 and the GPU(s) 708). The cache(s) 712 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 704 may include an arithmetic logic unit(s) (ALU(s)) which may be leveraged in performing processing with respect to any of the variety of tasks or operations of the vehicle 700—such as processing DNNs. In addition, the SoC(s) 704 may include a floating point unit(s) (FPU(s))—or other math coprocessor or numeric coprocessor types—for performing mathematical operations within the system. For example, the SoC(s) 104 may include one or more FPUs integrated as execution units within a CPU(s) 706 and/or GPU(s) 708.

The SoC(s) 704 may include one or more accelerators 714 (e.g., hardware accelerators, software accelerators, or a combination thereof). For example, the SoC(s) 704 may include a hardware acceleration cluster that may include optimized hardware accelerators and/or large on-chip memory. The large on-chip memory (e.g., 4 MB of SRAM), may enable the hardware acceleration cluster to accelerate neural networks and other calculations. The hardware acceleration cluster may be used to complement the GPU(s) 708 and to off-load some of the tasks of the GPU(s) 708 (e.g., to free up more cycles of the GPU(s) 708 for performing other tasks). As an example, the accelerator(s) 714 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 714 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 708, and by using an inference accelerator, for example, a designer may target either the DLA(s) or the GPU(s) 708 for any function. For example, the designer may focus processing of CNNs and floating point operations on the DLA(s) and leave other functions to the GPU(s) 708 and/or other accelerator(s) 714.

The accelerator(s) 714 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may enable components of the PVA(s) to access the system memory independently of the CPU(s) 706. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 714 (e.g., the hardware acceleration cluster) may include a computer vision network on-chip and SRAM, for providing a high-bandwidth, low latency SRAM for the accelerator(s) 714. In some examples, the on-chip memory may include at least 4 MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 704 may include a real-time ray-tracing hardware accelerator, such as described in U.S. patent application Ser. No. 16/101,232, filed on Aug. 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LIDAR data for purposes of localization and/or other functions, and/or for other uses. In some embodiments, one or more tree traversal units (TTUs) may be used for executing one or more ray-tracing related operations.

The accelerator(s) 714 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. In other words, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to provide Processed RADAR. In other examples, the PVA is used for time of flight depth processing, by processing raw time of flight data to provide processed time of flight data, for example.

The DLA may be used to run any type of network to enhance control and driving safety, including for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 766 output that correlates with the vehicle 700 orientation, distance, 3D location estimates of the object obtained from the neural network and/or other sensors (e.g., LIDAR sensor(s) 764 or RADAR sensor(s) 760), among others.

The SoC(s) 704 may include data store(s) 716 (e.g., memory). The data store(s) 716 may be on-chip memory of the SoC(s) 704, which may store neural networks to be executed on the GPU and/or the DLA. In some examples, the data store(s) 716 may be large enough in capacity to store multiple instances of neural networks for redundancy and safety. The data store(s) 712 may comprise L2 or L3 cache(s) 712. Reference to the data store(s) 716 may include reference to the memory associated with the PVA, DLA, and/or other accelerator(s) 714, as described herein.

The SoC(s) 704 may include one or more processor(s) 710 (e.g., embedded processors). The processor(s) 710 may include a boot and power management processor that may be a dedicated processor and subsystem to handle boot power and management functions and related security enforcement. The boot and power management processor may be a part of the SoC(s) 704 boot sequence and may provide runtime power management services. The boot power and management processor may provide clock and voltage programming, assistance in system low power state transitions, management of SoC(s) 704 thermals and temperature sensors, and/or management of the SoC(s) 704 power states. Each temperature sensor may be implemented as a ring-oscillator whose output frequency is proportional to temperature, and the SoC(s) 704 may use the ring-oscillators to detect temperatures of the CPU(s) 706, GPU(s) 708, and/or accelerator(s) 714. If temperatures are determined to exceed a threshold, the boot and power management processor may enter a temperature fault routine and put the SoC(s) 704 into a lower power state and/or put the vehicle 700 into a chauffeur to safe stop mode (e.g., bring the vehicle 700 to a safe stop).

The processor(s) 710 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 710 may further include an always on processor engine that may provide necessary hardware features to support low power sensor management and wake use cases. The always on processor engine may include a processor core, a tightly coupled RAM, supporting peripherals (e.g., timers and interrupt controllers), various I/O controller peripherals, and routing logic.

The processor(s) 710 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 710 may further include a real-time camera engine that may include a dedicated processor subsystem for handling real-time camera management.

The processor(s) 710 may further include a high-dynamic range signal processor that may include an image signal processor that is a hardware engine that is part of the camera processing pipeline.

The processor(s) 710 may include a video image compositor that may be a processing block (e.g., implemented on a microprocessor) that implements video post-processing functions needed by a video playback application to produce the final image for the player window. The video image compositor may perform lens distortion correction on wide-view camera(s) 770, surround camera(s) 774, and/or on in-cabin monitoring camera sensors. In-cabin monitoring camera sensor is preferably monitored by a neural network running on another instance of the Advanced SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 708 is not required to continuously render new surfaces. Even when the GPU(s) 708 is powered on and active doing 3D rendering, the video image compositor may be used to offload the GPU(s) 708 to improve performance and responsiveness.

The SoC(s) 704 may further include a mobile industry processor interface (MIPI) camera serial interface for receiving video and input from cameras, a high-speed interface, and/or a video input block that may be used for camera and related pixel input functions. The SoC(s) 704 may further include an input/output controller(s) that may be controlled by software and may be used for receiving I/O signals that are uncommitted to a specific role.

The SoC(s) 704 may further include a broad range of peripheral interfaces to enable communication with peripherals, audio codecs, power management, and/or other devices. The SoC(s) 704 may be used to process data from cameras (e.g., connected over Gigabit Multimedia Serial Link and Ethernet), sensors (e.g., LIDAR sensor(s) 764, RADAR sensor(s) 760, etc. that may be connected over Ethernet), data from bus 702 (e.g., speed of vehicle 700, steering wheel position, etc.), data from GNSS sensor(s) 758 (e.g., connected over Ethernet or CAN bus). The SoC(s) 704 may further include dedicated high-performance mass storage controllers that may include their own DMA engines, and that may be used to free the CPU(s) 706 from routine data management tasks.

The SoC(s) 704 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 704 may be faster, more reliable, and even more energy-efficient and space-efficient than conventional systems. For example, the accelerator(s) 714, when combined with the CPU(s) 706, the GPU(s) 708, and the data store(s) 716, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to enable Level 3-5 autonomous driving functionality. For example, a CNN executing on the DLA or dGPU (e.g., the GPU(s) 720) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 708.

In some examples, a CNN for facial recognition and vehicle owner identification may use data from camera sensors to identify the presence of an authorized driver and/or owner of the vehicle 700. The always on sensor processing engine may be used to unlock the vehicle when the owner approaches the driver door and turn on the lights, and, in security mode, to disable the vehicle when the owner leaves the vehicle. In this way, the SoC(s) 704 provide for security against theft and/or carjacking.

In another example, a CNN for emergency vehicle detection and identification may use data from microphones 796 to detect and identify emergency vehicle sirens. In contrast to conventional systems, that use general classifiers to detect sirens and manually extract features, the SoC(s) 704 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 758. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 762, until the emergency vehicle(s) passes.

The vehicle may include a CPU(s) 718 (e.g., discrete CPU(s), or dCPU(s)), that may be coupled to the SoC(s) 704 via a high-speed interconnect (e.g., PCIe). The CPU(s) 718 may include an X86 processor, for example. The CPU(s) 718 may be used to perform any of a variety of functions, including arbitrating potentially inconsistent results between ADAS sensors and the SoC(s) 704, and/or monitoring the status and health of the controller(s) 736 and/or infotainment SoC 730, for example.

The vehicle 700 may include a GPU(s) 720 (e.g., discrete GPU(s), or dGPU(s)), that may be coupled to the SoC(s) 704 via a high-speed interconnect (e.g., NVIDIA's NVLINK). The GPU(s) 720 may provide additional artificial intelligence functionality, such as by executing redundant and/or different neural networks, and may be used to train and/or update neural networks based on input (e.g., sensor data) from sensors of the vehicle 700.

The vehicle 700 may further include the network interface 724 which may include one or more wireless antennas 726 (e.g., one or more wireless antennas for different communication protocols, such as a cellular antenna, a Bluetooth antenna, etc.). The network interface 724 may be used to enable wireless connectivity over the Internet with the cloud (e.g., with the server(s) 778 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 700 information about vehicles in proximity to the vehicle 700 (e.g., vehicles in front of, on the side of, and/or behind the vehicle 700). This functionality may be part of a cooperative adaptive cruise control functionality of the vehicle 700.

The network interface 724 may include a SoC that provides modulation and demodulation functionality and enables the controller(s) 736 to communicate over wireless networks. The network interface 724 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 700 may further include data store(s) 728 which may include off-chip (e.g., off the SoC(s) 704) storage. The data store(s) 728 may include one or more storage elements including RAM, SRAM, DRAM, VRAM, Flash, hard disks, and/or other components and/or devices that may store at least one bit of data.

The vehicle 700 may further include GNSS sensor(s) 758. The GNSS sensor(s) 758 (e.g., GPS, assisted GPS sensors, differential GPS (DGPS) sensors, etc.), to assist in mapping, perception, occupancy grid generation, and/or path planning functions. Any number of GNSS sensor(s) 758 may be used, including, for example and without limitation, a GPS using a USB connector with an Ethernet to Serial (RS-232) bridge.

The vehicle 700 may further include RADAR sensor(s) 760. The RADAR sensor(s) 760 may be used by the vehicle 700 for long-range vehicle detection, even in darkness and/or severe weather conditions. RADAR functional safety levels may be ASIL B. The RADAR sensor(s) 760 may use the CAN and/or the bus 702 (e.g., to transmit data generated by the RADAR sensor(s) 760) for control and to access object tracking data, with access to Ethernet to access raw data in some examples. A wide variety of RADAR sensor types may be used. For example, and without limitation, the RADAR sensor(s) 760 may be suitable for front, rear, and side RADAR use. In some example, Pulse Doppler RADAR sensor(s) are used.

The RADAR sensor(s) 760 may include different configurations, such as long range with narrow field of view, short range with wide field of view, short range side coverage, etc. In some examples, long-range RADAR may be used for adaptive cruise control functionality. The long-range RADAR systems may provide a broad field of view realized by two or more independent scans, such as within a 250 m range. The RADAR sensor(s) 760 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 700 surroundings at higher speeds with minimal interference from traffic in adjacent lanes. The other two antennae may expand the field of view, making it possible to quickly detect vehicles entering or leaving the vehicle's 700 lane.

Mid-range RADAR systems may include, as an example, a range of up to 760 m (front) or 80 m (rear), and a field of view of up to 42 degrees (front) or 750 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 700 may further include ultrasonic sensor(s) 762. The ultrasonic sensor(s) 762, which may be positioned at the front, back, and/or the sides of the vehicle 700, may be used for park assist and/or to create and update an occupancy grid. A wide variety of ultrasonic sensor(s) 762 may be used, and different ultrasonic sensor(s) 762 may be used for different ranges of detection (e.g., 2.5 m, 4 m). The ultrasonic sensor(s) 762 may operate at functional safety levels of ASIL B.

The vehicle 700 may include LIDAR sensor(s) 764. The LIDAR sensor(s) 764 may be used for object and pedestrian detection, emergency braking, collision avoidance, and/or other functions. The LIDAR sensor(s) 764 may be functional safety level ASIL B. In some examples, the vehicle 700 may include multiple LIDAR sensors 764 (e.g., two, four, six, etc.) that may use Ethernet (e.g., to provide data to a Gigabit Ethernet switch).

In some examples, the LIDAR sensor(s) 764 may be capable of providing a list of objects and their distances for a 360-degree field of view. Commercially available LIDAR sensor(s) 764 may have an advertised range of approximately 700 m, with an accuracy of 2 cm-3 cm, and with support for a 700 Mbps Ethernet connection, for example. In some examples, one or more non-protruding LIDAR sensors 764 may be used. In such examples, the LIDAR sensor(s) 764 may be implemented as a small device that may be embedded into the front, rear, sides, and/or corners of the vehicle 700. The LIDAR sensor(s) 764, in such examples, may provide up to a 120-degree horizontal and 35-degree vertical field-of-view, with a 200 m range even for low-reflectivity objects. Front-mounted LIDAR sensor(s) 764 may be configured for a horizontal field of view between 45 degrees and 135 degrees.

In some examples, LIDAR technologies, such as 3D flash LIDAR, may also be used. 3D Flash LIDAR uses a flash of a laser as a transmission source, to illuminate vehicle surroundings up to approximately 200 m. A flash LIDAR unit includes a receptor, which records the laser pulse transit time and the reflected light on each pixel, which in turn corresponds to the range from the vehicle to the objects. Flash LIDAR may allow for highly accurate and distortion-free images of the surroundings to be generated with every laser flash. In some examples, four flash LIDAR sensors may be deployed, one at each side of the vehicle 700. Available 3D flash LIDAR systems include a solid-state 3D staring array LIDAR camera with no moving parts other than a fan (e.g., a non-scanning LIDAR device). The flash LIDAR device may use a 5 nanosecond class I (eye-safe) laser pulse per frame and may capture the reflected laser light in the form of 3D range point clouds and co-registered intensity data. By using flash LIDAR, and because flash LIDAR is a solid-state device with no moving parts, the LIDAR sensor(s) 764 may be less susceptible to motion blur, vibration, and/or shock.

The vehicle may further include IMU sensor(s) 766. The IMU sensor(s) 766 may be located at a center of the rear axle of the vehicle 700, in some examples. The IMU sensor(s) 766 may include, for example and without limitation, an accelerometer(s), a magnetometer(s), a gyroscope(s), a magnetic compass(es), and/or other sensor types. In some examples, such as in six-axis applications, the IMU sensor(s) 766 may include accelerometers and gyroscopes, while in nine-axis applications, the IMU sensor(s) 766 may include accelerometers, gyroscopes, and magnetometers.

In some embodiments, the IMU sensor(s) 766 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 766 may enable the vehicle 700 to estimate heading without requiring input from a magnetic sensor by directly observing and correlating the changes in velocity from GPS to the IMU sensor(s) 766. In some examples, the IMU sensor(s) 766 and the GNSS sensor(s) 758 may be combined in a single integrated unit.

The vehicle may include microphone(s) 796 placed in and/or around the vehicle 700. The microphone(s) 796 may be used for emergency vehicle detection and identification, among other things.

The vehicle may further include any number of camera types, including stereo camera(s) 768, wide-view camera(s) 770, infrared camera(s) 772, surround camera(s) 774, long-range and/or mid-range camera(s) 798, and/or other camera types. The cameras may be used to capture image data around an entire periphery of the vehicle 700. The types of cameras used depends on the embodiments and requirements for the vehicle 700, and any combination of camera types may be used to provide the necessary coverage around the vehicle 700. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 7A and FIG. 7B.

The vehicle 700 may further include vibration sensor(s) 742. The vibration sensor(s) 742 may measure vibrations of components of the vehicle, such as the axle(s). For example, changes in vibrations may indicate a change in road surfaces. In another example, when two or more vibration sensors 742 are used, the differences between the vibrations may be used to determine friction or slippage of the road surface (e.g., when the difference in vibration is between a power-driven axle and a freely rotating axle).

The vehicle 700 may include an ADAS system 738. The ADAS system 738 may include a SoC, in some examples. The ADAS system 738 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 760, LIDAR sensor(s) 764, and/or a camera(s). The ACC systems may include longitudinal ACC and/or lateral ACC. Longitudinal ACC monitors and controls the distance to the vehicle immediately ahead of the vehicle 700 and automatically adjust the vehicle speed to maintain a safe distance from vehicles ahead. Lateral ACC performs distance keeping, and advises the vehicle 700 to change lanes when necessary. Lateral ACC is related to other ADAS applications such as LCA and CWS.

CACC uses information from other vehicles that may be received via the network interface 724 and/or the wireless antenna(s) 726 from other vehicles via a wireless link, or indirectly, over a network connection (e.g., over the Internet). Direct links may be provided by a vehicle-to-vehicle (V2V) communication link, while indirect links may be infrastructure-to-vehicle (I2V) communication link. In general, the V2V communication concept provides information about the immediately preceding vehicles (e.g., vehicles immediately ahead of and in the same lane as the vehicle 700), while the I2V communication concept provides information about traffic further ahead. CACC systems may include either or both I2V and V2V information sources. Given the information of the vehicles ahead of the vehicle 700, CACC may be more reliable and it has potential to improve traffic flow smoothness and reduce congestion on the road.

FCW systems are designed to alert the driver to a hazard, so that the driver may take corrective action. FCW systems use a front-facing camera and/or RADAR sensor(s) 760, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 760, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 700 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 700 if the vehicle 700 starts to exit the lane.

BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s) 760, coupled to a dedicated processor, DSP, FPGA, and/or ASIC, that is electrically coupled to driver feedback, such as a display, speaker, and/or vibrating component.

RCTW systems may provide visual, audible, and/or tactile notification when an object is detected outside the rear-camera range when the vehicle 700 is backing up. Some RCTW systems include AEB to ensure that the vehicle brakes are applied to avoid a crash. RCTW systems may use one or more rear-facing RADAR sensor(s) 760, coupled to a dedicated processor, DSP, FPGA, and/or ASIC, that is electrically coupled to driver feedback, such as a display, speaker, and/or vibrating component.

Conventional ADAS systems may be prone to false positive results which may be annoying and distracting to a driver, but typically are not catastrophic, because the ADAS systems alert the driver and allow the driver to decide whether a safety condition truly exists and act accordingly. However, in an autonomous vehicle 700, the vehicle 700 itself must, in the case of conflicting results, decide whether to heed the result from a primary computer or a secondary computer (e.g., a first controller 736 or a second controller 736). For example, in some embodiments, the ADAS system 738 may be a backup and/or secondary computer for providing perception information to a backup computer rationality module. The backup computer rationality monitor may run a redundant diverse software on hardware components to detect faults in perception and dynamic driving tasks. Outputs from the ADAS system 738 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 704.

In other examples, ADAS system 738 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 738 may be fed into the primary computer's perception block and/or the primary computer's dynamic driving task block. For example, if the ADAS system 738 indicates a forward crash warning due to an object immediately ahead, the perception block may use this information when identifying objects. In other examples, the secondary computer may have its own neural network which is trained and thus reduces the risk of false positives, as described herein.

The vehicle 700 may further include the infotainment SoC 730 (e.g., an in-vehicle infotainment system (IVI)). Although illustrated and described as a SoC, the infotainment system may not be a SoC, and may include two or more discrete components. The infotainment SoC 730 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the vehicle 700. For example, the infotainment SoC 730 may radios, disk players, navigation systems, video players, USB and Bluetooth connectivity, carputers, in-car entertainment, Wi-Fi, steering wheel audio controls, hands free voice control, a heads-up display (HUD), an HMI display 734, a telematics device, a control panel (e.g., for controlling and/or interacting with various components, features, and/or systems), and/or other components. The infotainment SoC 730 may further be used to provide information (e.g., visual and/or audible) to a user(s) of the vehicle, such as information from the ADAS system 738, autonomous driving information such as planned vehicle maneuvers, trajectories, surrounding environment information (e.g., intersection information, vehicle information, road information, etc.), and/or other information.

The infotainment SoC 730 may include GPU functionality. The infotainment SoC 730 may communicate over the bus 702 (e.g., CAN bus, Ethernet, etc.) with other devices, systems, and/or components of the vehicle 700. In some examples, the infotainment SoC 730 may be coupled to a supervisory MCU such that the GPU of the infotainment system may perform some self-driving functions in the event that the primary controller(s) 736 (e.g., the primary and/or backup computers of the vehicle 700) fail. In such an example, the infotainment SoC 730 may put the vehicle 700 into a chauffeur to safe stop mode, as described herein.

The vehicle 700 may further include an instrument cluster 732 (e.g., a digital dash, an electronic instrument cluster, a digital instrument panel, etc.). The instrument cluster 732 may include a controller and/or supercomputer (e.g., a discrete controller or supercomputer). The instrument cluster 732 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 730 and the instrument cluster 732. In other words, the instrument cluster 732 may be included as part of the infotainment SoC 730, or vice versa.

FIG. 7D is a system diagram for communication between cloud-based server(s) and the example autonomous vehicle 700 of FIG. 7A, in accordance with some embodiments of the present disclosure. The system 776 may include server(s) 778, network(s) 790, and vehicles, including the vehicle 700. The server(s) 778 may include a plurality of GPUs 784(A)-784(H) (collectively referred to herein as GPUs 784), PCIe switches 782(A)-782(H) (collectively referred to herein as PCIe switches 782), and/or CPUs 780(A)-780(B) (collectively referred to herein as CPUs 780). The GPUs 784, the CPUs 780, and the PCIe switches may be interconnected with high-speed interconnects such as, for example and without limitation, NVLink interfaces 788 developed by NVIDIA and/or PCIe connections 786. In some examples, the GPUs 784 are connected via NVLink and/or NVSwitch SoC and the GPUs 784 and the PCIe switches 782 are connected via PCIe interconnects. Although eight GPUs 784, two CPUs 780, and two PCIe switches are illustrated, this is not intended to be limiting. Depending on the embodiment, each of the server(s) 778 may include any number of GPUs 784, CPUs 780, and/or PCIe switches. For example, the server(s) 778 may each include eight, sixteen, thirty-two, and/or more GPUs 784.

The server(s) 778 may receive, over the network(s) 790 and from the vehicles, image data representative of images showing unexpected or changed road conditions, such as recently commenced road-work. The server(s) 778 may transmit, over the network(s) 790 and to the vehicles, neural networks 792, updated neural networks 792, and/or map information 794, including information regarding traffic and road conditions. The updates to the map information 794 may include updates for the HD map 722, such as information regarding construction sites, potholes, detours, flooding, and/or other obstructions. In some examples, the neural networks 792, the updated neural networks 792, and/or the map information 794 may have resulted from new training and/or experiences represented in data received from any number of vehicles in the environment, and/or based on training performed at a datacenter (e.g., using the server(s) 778 and/or other servers).

The server(s) 778 may be used to train machine learning models (e.g., neural networks) based on training data. The training data may be generated by the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 790, and/or the machine learning models may be used by the server(s) 778 to remotely monitor the vehicles.

In some examples, the server(s) 778 may receive data from the vehicles and apply the data to up-to-date real-time neural networks for real-time intelligent inferencing. The server(s) 778 may include deep-learning supercomputers and/or dedicated AI computers powered by GPU(s) 784, such as a DGX and DGX Station machines developed by NVIDIA. However, in some examples, the server(s) 778 may include deep learning infrastructure that use only CPU-powered datacenters.

The deep-learning infrastructure of the server(s) 778 may be capable of fast, real-time inferencing, and may use that capability to evaluate and verify the health of the processors, software, and/or associated hardware in the vehicle 700. For example, the deep-learning infrastructure may receive periodic updates from the vehicle 700, such as a sequence of images and/or objects that the vehicle 700 has located in that sequence of images (e.g., via computer vision and/or other machine learning object classification techniques). The deep-learning infrastructure may run its own neural network to identify the objects and compare them with the objects identified by the vehicle 700 and, if the results do not match and the infrastructure concludes that the AI in the vehicle 700 is malfunctioning, the server(s) 778 may transmit a signal to the vehicle 700 instructing a fail-safe computer of the vehicle 700 to assume control, notify the passengers, and complete a safe parking maneuver.

For inferencing, the server(s) 778 may include the GPU(s) 784 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

Example Computing Device

FIG. 8 is a block diagram of an example computing device(s) 800 suitable for use in implementing some embodiments of the present disclosure. Computing device 800 may include an interconnect system 802 that directly or indirectly couples the following devices: memory 804, one or more central processing units (CPUs) 806, one or more graphics processing units (GPUs) 808, a communication interface 810, input/output (I/O) ports 812, input/output components 814, a power supply 816, one or more presentation components 818 (e.g., display(s)), and one or more logic units 820. In at least one embodiment, the computing device(s) 800 may comprise one or more virtual machines (VMs), and/or any of the components thereof may comprise virtual components (e.g., virtual hardware components). For non-limiting examples, one or more of the GPUs 808 may comprise one or more vGPUs, one or more of the CPUs 806 may comprise one or more vCPUs, and/or one or more of the logic units 820 may comprise one or more virtual logic units. As such, a computing device(s) 800 may include discrete components (e.g., a full GPU dedicated to the computing device 800), virtual components (e.g., a portion of a GPU dedicated to the computing device 800), or a combination thereof.

Although the various blocks of FIG. 8 are shown as connected via the interconnect system 802 with lines, this is not intended to be limiting and is for clarity only. For example, in some embodiments, a presentation component 818, such as a display device, may be considered an I/O component 814 (e.g., if the display is a touch screen). As another example, the CPUs 806 and/or GPUs 808 may include memory (e.g., the memory 804 may be representative of a storage device in addition to the memory of the GPUs 808, the CPUs 806, and/or other components). In other words, the computing device of FIG. 8 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 8.

The interconnect system 802 may represent one or more links or busses, such as an address bus, a data bus, a control bus, or a combination thereof. The interconnect system 802 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 806 may be directly connected to the memory 804. Further, the CPU 806 may be directly connected to the GPU 808. Where there is direct, or point-to-point connection between components, the interconnect system 802 may include a PCIe link to carry out the connection. In these examples, a PCI bus need not be included in the computing device 800.

The memory 804 may include any of a variety of computer-readable media. The computer-readable media may be any available media that may be accessed by the computing device 800. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 804 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 800. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 806 may be configured to execute at least some of the computer-readable instructions to control one or more components of the computing device 800 to perform one or more of the methods and/or processes described herein. The CPU(s) 806 may each include one or more cores (e.g., one, two, four, eight, twenty-eight, seventy-two, etc.) that are capable of handling a multitude of software threads simultaneously. The CPU(s) 806 may include any type of processor, and may include different types of processors depending on the type of computing device 800 implemented (e.g., processors with fewer cores for mobile devices and processors with more cores for servers). For example, depending on the type of computing device 800, the processor may be an Advanced RISC Machines (ARM) processor implemented using Reduced Instruction Set Computing (RISC) or an x86 processor implemented using Complex Instruction Set Computing (CISC). The computing device 800 may include one or more CPUs 806 in addition to one or more microprocessors or supplementary co-processors, such as math co-processors.

In addition to or alternatively from the CPU(s) 806, the GPU(s) 808 may be configured to execute at least some of the computer-readable instructions to control one or more components of the computing device 800 to perform one or more of the methods and/or processes described herein. One or more of the GPU(s) 808 may be an integrated GPU (e.g., with one or more of the CPU(s) 806 and/or one or more of the GPU(s) 808 may be a discrete GPU. In embodiments, one or more of the GPU(s) 808 may be a coprocessor of one or more of the CPU(s) 806. The GPU(s) 808 may be used by the computing device 800 to render graphics (e.g., 3D graphics) or perform general purpose computations. For example, the GPU(s) 808 may be used for General-Purpose computing on GPUs (GPGPU). The GPU(s) 808 may include hundreds or thousands of cores that are capable of handling hundreds or thousands of software threads simultaneously. The GPU(s) 808 may generate pixel data for output images in response to rendering commands (e.g., rendering commands from the CPU(s) 806 received via a host interface). The GPU(s) 808 may include graphics memory, such as display memory, for storing pixel data or any other suitable data, such as GPGPU data. The display memory may be included as part of the memory 804. The GPU(s) 808 may include two or more GPUs operating in parallel (e.g., via a link). The link may directly connect the GPUs (e.g., using NVLINK) or may connect the GPUs through a switch (e.g., using NVSwitch). When combined together, each GPU 808 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 806 and/or the GPU(s) 808, the logic unit(s) 820 may be configured to execute at least some of the computer-readable instructions to control one or more components of the computing device 800 to perform one or more of the methods and/or processes described herein. In embodiments, the CPU(s) 806, the GPU(s) 808, and/or the logic unit(s) 820 may discretely or jointly perform any combination of the methods, processes and/or portions thereof. One or more of the logic units 820 may be part of and/or integrated in one or more of the CPU(s) 806 and/or the GPU(s) 808 and/or one or more of the logic units 820 may be discrete components or otherwise external to the CPU(s) 806 and/or the GPU(s) 808. In embodiments, one or more of the logic units 820 may be a coprocessor of one or more of the CPU(s) 806 and/or one or more of the GPU(s) 808.

Examples of the logic unit(s) 820 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 810 may include one or more receivers, transmitters, and/or transceivers that enable the computing device 800 to communicate with other computing devices via an electronic communication network, included wired and/or wireless communications. The communication interface 810 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 820 and/or communication interface 810 may include one or more data processing units (DPUs) to transmit data received over a network and/or through interconnect system 802 directly to (e.g., a memory of) one or more GPU(s) 808.

The I/O ports 812 may enable the computing device 800 to be logically coupled to other devices including the I/O components 814, the presentation component(s) 818, and/or other components, some of which may be built in to (e.g., integrated in) the computing device 800. Illustrative I/O components 814 include a microphone, mouse, keyboard, joystick, game pad, game controller, satellite dish, scanner, printer, wireless device, etc. The I/O components 814 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 800. The computing device 800 may be include depth cameras, such as stereoscopic camera systems, infrared camera systems, RGB camera systems, touchscreen technology, and combinations of these, for gesture detection and recognition. Additionally, the computing device 800 may include accelerometers or gyroscopes (e.g., as part of an inertia measurement unit (IMU)) that enable detection of motion. In some examples, the output of the accelerometers or gyroscopes may be used by the computing device 800 to render immersive augmented reality or virtual reality.

The power supply 816 may include a hard-wired power supply, a battery power supply, or a combination thereof. The power supply 816 may provide power to the computing device 800 to enable the components of the computing device 800 to operate.

The presentation component(s) 818 may include a display (e.g., a monitor, a touch screen, a television screen, a heads-up-display (HUD), other display types, or a combination thereof), speakers, and/or other presentation components. The presentation component(s) 818 may receive data from other components (e.g., the GPU(s) 808, the CPU(s) 806, DPUs, etc.), and output the data (e.g., as an image, video, sound, etc.).

Example Data Center

FIG. 9 illustrates an example data center 900 that may be used in at least one embodiments of the present disclosure. The data center 900 may include a data center infrastructure layer 910, a framework layer 920, a software layer 930, and/or an application layer 940.

As shown in FIG. 9, the data center infrastructure layer 910 may include a resource orchestrator 912, grouped computing resources 914, and node computing resources (“node C.R.s”) 916(1)-916(N), where “N” represents any whole, positive integer. In at least one embodiment, node C.R.s 916(1)-916(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 916(1)-916(N) may correspond to a server having one or more of the above-mentioned computing resources. In addition, in some embodiments, the node C.R.s 916(1)-9161(N) may include one or more virtual components, such as vGPUs, vCPUs, and/or the like, and/or one or more of the node C.R.s 916(1)-916(N) may correspond to a virtual machine (VM).

In at least one embodiment, grouped computing resources 914 may include separate groupings of node C.R.s 916 housed within one or more racks (not shown), or many racks housed in data centers at various geographical locations (also not shown). Separate groupings of node C.R.s 916 within grouped computing resources 914 may include grouped compute, network, memory or storage resources that may be configured or allocated to support one or more workloads. In at least one embodiment, several node C.R.s 916 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 912 may configure or otherwise control one or more node C.R.s 916(1)-916(N) and/or grouped computing resources 914. In at least one embodiment, resource orchestrator 912 may include a software design infrastructure (SDI) management entity for the data center 900. The resource orchestrator 912 may include hardware, software, or some combination thereof.

In at least one embodiment, as shown in FIG. 9, framework layer 920 may include a job scheduler 933, a configuration manager 934, a resource manager 936, and/or a distributed file system 938. The framework layer 920 may include a framework to support software 932 of software layer 930 and/or one or more application(s) 942 of application layer 940. The software 932 or application(s) 942 may respectively include web-based service software or applications, such as those provided by Amazon Web Services, Google Cloud and Microsoft Azure. The framework layer 920 may be, but is not limited to, a type of free and open-source software web application framework such as Apache Spark™ (hereinafter “Spark”) that may utilize distributed file system 938 for large-scale data processing (e.g., “big data”). In at least one embodiment, job scheduler 933 may include a Spark driver to facilitate scheduling of workloads supported by various layers of data center 900. The configuration manager 934 may be capable of configuring different layers such as software layer 930 and framework layer 920 including Spark and distributed file system 938 for supporting large-scale data processing. The resource manager 936 may be capable of managing clustered or grouped computing resources mapped to or allocated for support of distributed file system 938 and job scheduler 933. In at least one embodiment, clustered or grouped computing resources may include grouped computing resource 914 at data center infrastructure layer 910. The resource manager 936 may coordinate with resource orchestrator 912 to manage these mapped or allocated computing resources.

In at least one embodiment, software 932 included in software layer 930 may include software used by at least portions of node C.R.s 916(1)-916(N), grouped computing resources 914, and/or distributed file system 938 of framework layer 920. One or more types of software may include, but are not limited to, Internet web page search software, e-mail virus scan software, database software, and streaming video content software.

In at least one embodiment, application(s) 942 included in application layer 940 may include one or more types of applications used by at least portions of node C.R.s 916(1)-916(N), grouped computing resources 914, and/or distributed file system 938 of framework layer 920. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 934, resource manager 936, and resource orchestrator 912 may implement any number and type of self-modifying actions based on any amount and type of data acquired in any technically feasible fashion. Self-modifying actions may relieve a data center operator of data center 900 from making possibly bad configuration decisions and possibly avoiding underutilized and/or poor performing portions of a data center.

The data center 900 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 900. In at least one embodiment, trained or deployed machine learning models corresponding to one or more neural networks may be used to infer or predict information using resources described above with respect to the data center 900 by using weight parameters calculated through one or more training techniques, such as but not limited to those described herein.

In at least one embodiment, the data center 900 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 800 of FIG. 8—e.g., each device may include similar components, features, and/or functionality of the computing device(s) 800. In addition, where backend devices (e.g., servers, NAS, etc.) are implemented, the backend devices may be included as part of a data center 900, an example of which is described in more detail herein with respect to FIG. 9.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 800 described herein with respect to FIG. 8. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A processor comprising:
one or more circuits to:
generate a first lane graph including, for at least one lane of the first lane graph, a plurality of nodes longitudinally spaced within the at least one lane and a plurality of edges, each edge connecting a pair of nodes and having an associated cost value associated therewith;
generate a second lane graph using a deterministic algorithm, the first lane graph, and the associated cost value of each edge, the second lane graph including one or more paths from a source node to a target node, at least one path of the one or more paths including a subset of the plurality of nodes and a subset of the plurality of edges;
generate, using a stochastic algorithm and the second lane graph, a third lane graph including an updated associated cost value for at least one edge of the third lane graph; and
determine a driving route through the third lane graph based at least in part on the updated associated cost value for each edge.

2. The processor of claim 1, wherein the determination of the driving route is further based at least in part on live perception information.

3. The processor of claim 1, wherein the updated associated cost value for the at least one edge is computed based at least in part on a probability of an action associated with the edge being completed successfully.

4. The processor of claim 1, wherein the deterministic algorithm includes a shortest path algorithm.

5. The processor of claim 4, wherein the shortest path algorithm includes at least one of Djikstra's algorithm or an A* algorithm.

6. The processor of claim 1, wherein the stochastic algorithm includes a reinforcement learning algorithm.

7. The processor of claim 6, wherein the reinforcement learning algorithm includes a Markov Decision Process (MDP) algorithm, and the third lane graph is represented as an MDP.

8. The processor of claim 1, wherein the determination of the final driving route is executed using a behavior planner.

9. The processor of claim 1, wherein the first lane graph is generated using a route planner, and at least one of the second lane graph and the third lane graph is generated using a lane planner.

10. The processor of claim 1, wherein at least one of the associated cost value or the updated associated cost value is determined using at least one optimization category selected from a target reward, time spent, resources spent, discomfort, comfort, obstacle safety, path obedience, or wait condition obedience.

11. The processor of claim 1, wherein at least one node of the plurality of nodes corresponds to a vehicle state, and at least one edge of the plurality of edges corresponds to a vehicle action.

12. The processor of claim 11, wherein the vehicle action includes at least one of lane keeping, lane changing, turning, taking a fork, or merging.

13. The processor of claim 1, wherein the updated associated cost value for at least one edge is computed based at least in part on executing a modified value iteration that controls a number of iterations for executing the modified value iteration operation.

14. The processor of claim 1, wherein the associated cost value for the at least one edge and the updated associated cost value for the at least one edge correspond to expected time rewards associated with performing an action associated with the at least one edge.

15. The processor of claim 14, wherein at least one input used to compute the expected time rewards is computed by, at least in part, converting the at least one input to a time-based input.

16. The processor of claim 1, wherein the processor is comprised in at least one of:
a control system for an autonomous or semi-autonomous machine;
a perception system for an autonomous or semi-autonomous machine;
a system for performing simulation operations;
a system for performing light transport simulation;
a system for performing collaborative content creation for 3D assets;
a system for performing deep learning operations;
a system implemented using an edge device;
a system implemented using a robot;
a system for performing conversational AI operations;
a system for generating synthetic data;
a system incorporating one or more virtual machines (VMs);
a system implemented at least partially in a data center; or
a system implemented at least partially using cloud computing resources.

17. A system comprising:
one or more processors comprising processing circuitry to:
generate, based at least in part on map data representative of a map, a deterministic lane representation that includes a plurality of nodes and one or more edges extending between at least two nodes of the plurality of nodes, at least one edge of the one or more edges including an initial expected time reward;
generate, based at least in part on the deterministic lane representation, a probabilistic lane representation including at least a subset of the nodes and a subset of the edges, at least one edge of the subset of edges including an updated expected time reward; and
execute one or more operations based at least in part on the probabilistic lane representation.

18. The system of claim 17, wherein at least one edge is associated with a vehicle action, and the executing the one or more operations includes controlling a vehicle according to one or more vehicle actions associated with one or more edges of a selected path through the probabilistic lane representation.

19. The system of claim 18, wherein the one or more vehicle actions include at least one of lane keeping, lane changing, turning, taking a fork, or merging.

20. The system of claim 17, wherein the deterministic lane representation is generated based at least in part on executing a shortest path algorithm on an initial lane representation.

21. The system of claim 17, wherein the probabilistic lane representation is generated based at least in part on executing a reinforcement learning algorithm.

22. The system of claim 17, wherein the probabilistic lane representation includes a probability of success for at least one vehicle action associated with at least one edge of the edges.

23. The system of claim 17, wherein the execution of the one or more operations is further based at least in part on live perception information.

24. The system of claim 17, wherein the system is comprised in at least one of:
a control system for an autonomous or semi-autonomous machine;
a perception system for an autonomous or semi-autonomous machine;
a system for performing simulation operations;
a system for performing light transport simulation;
a system for performing collaborative content creation for 3D assets;
a system for performing deep learning operations;
a system implemented using an edge device;
a system implemented using a robot;
a system for performing conversational AI operations;
a system for generating synthetic data;
a system incorporating one or more virtual machines (VMs);
a system implemented at least partially in a data center; or
a system implemented at least partially using cloud computing resources.

25. A method comprising:
receiving data representative of at least a portion of a lane graph associated with a driving route of a vehicle, the lane graph including a plurality of nodes indicative of one or more potential locations within one or more lanes the lane graph and a plurality of edges connecting the plurality of nodes, at least one edge of the plurality of edges corresponding to a respective vehicle action of the vehicle within the one or more lanes;
computing, for each edge of the plurality of edges, a cost function based at least in part on a time expected for traversing a distance between a starting node and a node connected to the starting node as represented by the lane graph;
computing, for each edge of the plurality of edges, a probability of at least one vehicle action associated with the edge being successfully completed;
based at least in part on the cost function associated with each edge, computing a time reward for each node of the plurality of nodes; and
determining one or more driving routes including one or more candidate vehicle actions based at least in part on the time reward for each node of the plurality of nodes.

26. The method of claim 25, wherein the computing the time reward for each node in the plurality of nodes is based at least in part on executing a modified value iteration that controls a number of iterations for executing the modified value iteration operation that computes the time rewards.

27. The method of claim 25, wherein the time reward for each node is calculated by initially using a shortest path algorithm to identify time costs from a source node to any node on the lane graph.

28. The method of claim 25, wherein the method is executed by at least one of:
a control system for an autonomous or semi-autonomous machine;
a perception system for an autonomous or semi-autonomous machine;
a system for performing simulation operations;
a system for performing light transport simulation;
a system for performing collaborative content creation for 3D assets;
a system for performing deep learning operations;
a system implemented using an edge device;
a system implemented using a robot;
a system for performing conversational AI operations;
a system for generating synthetic data;
a system incorporating one or more virtual machines (VMs);
a system implemented at least partially in a data center; or
a system implemented at least partially using cloud computing resources.
